(19) United States
(12) Patent Application Publication
(10) Pub. No.: US 2004/0113783 A1
(43) Pub. Date: Jun. 17, 2004

(54) Container integrity management system

(75) Inventor: John Yagesh, Gaithersburg, MD (US)

Correspondence Address: WALL MARJAMA & BILINSKI, 101 SOUTH SALINA STREET, SUITE 400, SYRACUSE, NY, 13202, US

(73) Assignee: Millennium Information Systems, LLC

(21) Appl. No.: 10/317,595

(22) Filed: Dec. 11, 2002

(51) Int. Cl. G08B 13/14

(52) U.S. Cl. 340/568.1

(57) ABSTRACT

The present invention is directed to a transportation security system for monitoring at least one freight shipping container being transported by at least one cargo transport vehicle. The system includes a container locking seal configured to be removably coupled to the at least one freight shipping container to thereby seal the at least one freight shipping container when in a coupled position. The container locking seal includes at least one anti-tamper sensor and a seal communications device. A state recorder is disposed in the at least one cargo transport vehicle. The state recorder includes a recorder communications system being configured to communicate with the seal communications device. The state recorder also includes a data storage module configured to store sensor data.

### BACKGROUND OF THE INVENTION

1. Field of the Invention

The present invention relates generally to cargo security, and particularly to providing an intermodal security system that monitors, reports, and protects cargo during transportation.

2. Technical Background

Mankind has been engaged in trade and commerce from before the advent of recorded history. With the emergence of a global economy, trade has become increasingly important to individual national economies, and to the world's economy as a whole. Finished products, raw materials, and foodstuffs are transported between the various regions of the world via land and sea, and more recently, by way of air transport. A recent publication reports that over 240 million TEU-containers are shipped worldwide on an annual basis. While cargo security issues have always been a concern, the problem has been exacerbated by a number of factors.

Cargo loss due to theft has become a serious problem. Cargo is often misappropriated by shipping company employees, cargo handlers, and/or security personnel. Many insurance professionals believe that more than half of all major cargo thefts are planned in logistics departments, by employees at the shipper or manufacturer who are thought to be trustworthy. Certain authorities believe that gangs operating in many metropolitan areas are actually training some of their members in logistics, so they will be eligible for employment at desirable trucking, warehousing or forwarding firms.

Containers held in trucking company yards overnight are susceptible to theft of the entire container. Furthermore, thieves frequently know where full containers are going and will follow the delivering rig. They may also employ cell phones and use teams of spotters. When the driver stops for a break, they break in and steal what they want, re-sealing the container so the driver is unaware of any wrongdoing. The National Cargo Security Council estimates that cargo losses in the U.S. approach $10 billion, and $30-$100 billion worldwide. Trade experts estimate that cargo theft adds 15% to the price of imported goods.

Because of the emergence of terrorist threats and activities, container security has become a national security issue. Terrorists are exploiting transportation modalities such as air, rail, truck-trailer, vessel-barge, and bus. As evidenced by recent attacks, terrorists are directing, or seeking to direct, mobile transportation assets into office buildings and/or other heavily populated areas. On Feb. 26, 1993 a truck loaded with 1,500 pounds of fertilizer was detonated under the World Trade Center. On Apr. 19, 1995, the Alfred P. Murrah Federal Building in Oklahoma City was destroyed by a similar device, resulting in significant loss of life and property. Of course, the events of Sep. 11, 2001 will be forever ingrained in the minds of the American public.

While the terrorist threat may come from airliner and truck, one of the most significant threats may come from the misappropriation of ships/barges. For example, in September, 1993 a barge destroyed a section of a railroad bridge minutes before an Amtrak train was to pass over that bridge. This accident claimed the lives of 47 people. Of course, ships may also be intentionally directed into bridges or other objects as well. In light of the Valdez incident, ocean going vessels carrying oil products, or other hazardous materials (Hazmat), may intentionally be run aground to cause environmental damage to the nation's coastline.

The nation's Hazmat transportation infrastructure is also vulnerable. Hazardous materials, including flammables, caustics, toxins, and etcetera, present themselves for exploitation by terrorists in the most convenient form possible—as mobile targets that are unguarded and untracked. According to the U.S. D.O.T., over thirty-five percent of all of the hazardous materials being transported nationwide are carried by truck. Transportation of hazardous materials by ship/barge represent almost a quarter of the total hazmat tonnage being transported, while ten percent of these hazardous materials are carried by rail.

Another issue of concern involves smuggling terrorists across international borders. One publication reports that a suspected terrorist was found inside a shipping container in an Italian port. The suspect was equipped, in comfort, for the duration of the container's intended sea voyage from Italy to Halifax, Nova Scotia. The would-be-terrorist carried plans of airports, an aviation mechanic's certificate, and security passes. Other such containers were discovered as well.

Shipping containers may also be used by terrorists for arms shipments. Of greatest concern is the shipment of nuclear, chemical, or biological materials that can be used to produce weapons of mass destruction. Some of these materials are relatively small in size and could be hidden in shipping containers without being detected by governmental authorities. There is a grave concern that one or more suitcase-sized nuclear weapons have been developed by the old Soviet Union. If weapons such as these were to fall into the wrong hands the results could be devastating. The placement and use of such a device in a major city such as Washington D.C. could potentially decapitate our political system. The destruction of any city, whether New York, Los Angeles, or Chicago, would represent a grievous blow to the nation.

With the above scenarios in mind, improving container security is absolutely critical. In one approach that is commonly in use, locking mechanisms or security seals are applied to container doors to seal the cargo within the container. However, anyone who possesses the key or the combination, whether authorized or not, may gain access to the interior of a container. Further, locks can be easily picked or physically removed by other means. Thus, locking devices are a limited deterrent to thieves or terrorists.

In another approach that has been considered, alarm systems have been installed in warehouses and trucking company yards to prevent theft and tampering. These systems are typically configured to detect certain unusual events and generate local alarms such as horns or sirens in response to detection. Similarly, silent alarms may be generated and transmitted to central security entities, such as company security guards or the local police, for further investigation. However, this approach has drawbacks. Alarm systems are easily disabled by sophisticated thieves and/or terrorists. Furthermore, without a dedicated response and interdiction infrastructure, response time may also be an issue.

In another approach that has been considered, security systems have been proposed for tracking the whereabouts of trucks and trailers. These security systems typically include a GPS tracking device, a clock, a door sensor, and a memory device for recording the times and dates the container door was opened or closed. In some applications, both sensor data and tracking data may be transmitted back to a centralized trucking manager. Typically, the trucking manager may be responsible for supervising 30 to 60 drivers. These systems have several drawbacks. Many of these systems can be disabled by simply cutting a few wires. Even if a particular trucking manager does detect an alarm event, by the time the manager determines the cause of the sensor event (door-open condition), it is too late to prevent the theft. The perpetrators of the crime have left the scene. Further, it is often difficult for the trucking manager to determine if route deviations, unscheduled stops, or other suspicious activities have occurred. Another drawback relates to the fact that all of the above described security methods are implemented in a piecemeal fashion to protect cargo being trucked. There is no effective system in place to protect cargo being transported by rail, air, or sea.

What is needed is an integrated intermodal threat identification, detection, and notification (ITIDN) transportation security system. An ITIDN transportation security system is needed that vigilantly protects all transportation modalities including air, rail, truck, ship, barge and bus transport modes. What is needed is an intelligent low-cost locking seal that is adapted to monitor individual shipping containers and notify a centralized alarm monitoring facility.

### SUMMARY OF THE INVENTION

The present invention addresses the problems described above. The present invention provides an intermodal threat identification, detection, and notification (ITIDN) transportation security system. The present invention may be applied to all transportation modalities including air, rail, truck, ship, barge and bus transport modes. The instant security system provides inexpensive means for monitoring each shipping container. Container tampering is detected and reported almost instantaneously. Thus, the present invention provides a credible defense against terrorist attempts to smuggle weapons, weapons materials, and/or terrorist personnel by preventing unauthorized access to shipping containers. The threat of cargo theft or piracy is also mitigated. Thus, the ITIDN transportation security system of the present invention provides governmental and law enforcement agencies with the means to respond, in real-time, to cargo theft, piracy, and/or terrorist acts.

One aspect of the present invention is a transportation security system for monitoring at least one freight shipping container being transported by at least one cargo transport vehicle. The system includes a container locking seal configured to be removably coupled to the at least one freight shipping container to thereby seal the at least one freight shipping container when in a coupled position. The container locking seal includes at least one anti-tamper sensor and a seal communications device. A state recorder is disposed in the at least one cargo transport vehicle. The state recorder includes a recorder communications system being configured to communicate with the seal communications device. The state recorder also includes a data storage module configured to store sensor data.

In another aspect, the present invention includes a security system for monitoring a plurality of shipping containers being transported by a plurality of cargo transport vehicles. Each of the plurality of cargo vehicles transports at least one shipping container. The system includes a plurality of container locking seals. Each locking seal is configured to be removably coupled to one freight shipping container to thereby seal the freight shipping container when in a coupled position. Each container locking seal includes at least one anti-tamper sensor and a seal transceiver. The system also includes a plurality of state recorders. Each state recorder is disposed in one cargo transport vehicle. Each state recorder includes a recorder communications system configured to communicate with each seal transceiver disposed in the cargo transport vehicle. The state recorder also includes a data storage module configured to store data received from each locking seal disposed in the one cargo transport vehicle. The system also includes a container alarm monitoring system (CAMS) in communication with each of the plurality of state recorders in the system. The CAMS is configured to receive data from each of the plurality of state recorders and notify at least one enforcement entity in the event of an alarm condition.

In another aspect, the present invention includes a method for monitoring at least one freight shipping container being transported by at least one cargo transport vehicle. The method includes providing a container locking seal configured to be removably coupled to the at least one freight shipping container, to thereby seal the at least one freight shipping container when in a coupled position. The container locking seal includes at least one anti-tamper sensor and a seal communications device. The method also includes the step of communicating with the seal communications device to obtain sensor data from the at least one anti-tamper sensor.

In another aspect, the present invention includes a method for monitoring at least one freight shipping container being transported by at least one cargo transport vehicle from an point of origin to a destination point. The method includes providing route data corresponding to the path traversed by the at least one cargo transport vehicle from a point of origin to a destination point. An actual position of the at least one cargo vehicle is monitored to determine whether the actual position of the vehicle corresponds to the route data. An alarm condition is generated if the actual position of the vehicle does not correspond to the route data. At least one governmental entity is notified of the alarm condition.

In another aspect, the present invention includes a computer readable medium having stored thereon a data structure for packetizing data being transmitted between a container locking seal and a state recorder. The container locking seal is configured to be removably coupled to the at least one freight shipping container disposed on a cargo transport vehicle. The state recorder is disposed on the cargo transport vehicle. The data structure includes: a container locking seal identification field containing data that uniquely identifies the container locking seal; and a payload field containing either locking seal status data or state recorder command data depending on the source of the packet.

In another aspect, the present invention includes a computer readable medium having stored thereon a data structure for packetizing data being transmitted between a state recorder and a remote container alarm monitoring system (CAMS). The state recorder is configured to monitor at least one container locking seal configured to be removably coupled to the at least one freight shipping container disposed on a cargo transport vehicle. The state recorder is disposed on the cargo transport vehicle. The data structure includes: a state recorder identification field containing data that uniquely identifies the container locking seal; and a payload field containing either state recorder status data or CAMS command data depending on the source of the packet.

In another aspect, the present invention includes a method for use in a computerized system for identifying, detecting, and notifying personnel of alarm conditions based on data being transmitted from a state recorder to a container alarm monitoring system (CAMS). The state recorder is configured to monitor at least one container locking seal configured to be removably coupled to the at least one freight shipping container disposed in a cargo transport vehicle. The state recorder is disposed on the cargo transport vehicle. The CAMS includes a graphical user interface including at least one display and at least one selection device, and a method for providing and selecting from a menu on the display. The method includes retrieving a threat identification display screen. A plurality of threat mode icons are displayed on the threat identification display screen. A selection signal generated by the at least one selection device is processed by pointing the at least one selection device at one of the plurality of threat mode icons. A threat mode display screen is displayed corresponding to the threat mode icon selected in response to the step of processing.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description are merely exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principles and operation of the invention.

### BRIEF DESCRIPTION OF THE DRAWINGS

FIG. 1 is an overview diagram of the container integrity management system in accordance with the present invention;

FIG. 2 is a cross-sectional view of the intelligent container locking seal depicted in FIG. 1;

FIG. 3 is a block diagram of the intelligent container locking seal depicted in FIG. 1;

FIG. 4 is a three dimensional view showing the placement of an NBC sensor suite within a container;

FIG. 5 is a block diagram of the container state recorder depicted in FIG. 1;

FIG. 6 is a three dimensional view showing the form-factor of the container state recorder in accordance with one embodiment of the present invention;

FIG. 7 is a three dimensional view showing the hand-held PDA component of the container state recorder depicted in FIG. 6;

FIG. 8 is a diagrammatic depiction of the container alarm monitoring system (CAMS) depicted in FIG. 1;

FIG. 9 is a flow chart showing a method for monitoring container integrity in accordance with one embodiment of the present invention;

FIGS. 10A-10D show the data structure for each of the communication packets employed in the container integrity management system;

FIG. 11 shows a graphical user interface that includes an ITIDN threat screen displayed by CAMS in accordance with one embodiment of the present invention;

FIG. 12 shows a detail view of the ITIDN threat screen depicted in FIG. 11;

FIG. 13 shows a graphical user interface that includes an alert inventory screen in accordance with the present invention;

FIG. 14 shows a graphical user interface that includes a vessel-barge threat screen in accordance with the present invention;

FIG. 15 is a detail view of the vessel-barge threat screen depicted in FIG. 14;

FIG. 16 is a detail view of a display screen that shows the vessel-barge threat in the Eastern time zone in accordance with the present invention;

FIG. 17 is a detailed vessel-barge threat and notification screen in accordance with the present invention;

FIG. 18 is a graphical user interface that includes a vessel-barge detail screen in accordance with the present invention;

FIG. 19 is a graphical user interface that includes an enlarged map-view of the vessel-barge details screen shown in FIG. 18;

FIG. 20 is a graphical user interface that includes a further enlarged map-view of the vessel-barge details screen shown in FIG. 18;

FIG. 21 is a graphical user interface that includes a law enforcement notification response detail screen displayed by CAMS in accordance with one embodiment of the present invention; and

FIGS. 22A-22C show additional graphical user interface displays in accordance with the present invention.

### DETAILED DESCRIPTION

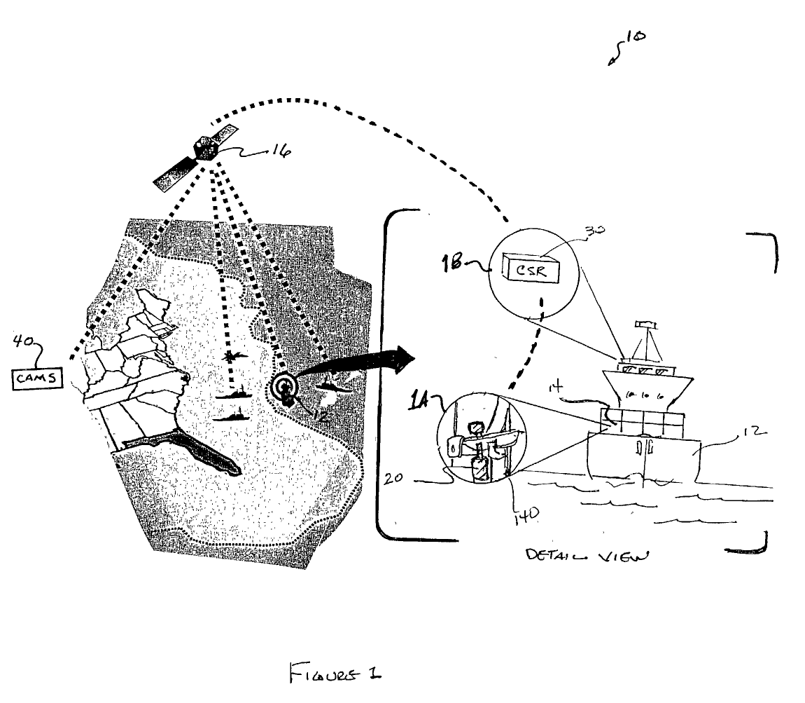

Reference will now be made in detail to the present exemplary embodiments of the invention, examples of which are illustrated in the accompanying drawings. Wherever possible, the same reference numbers will be used throughout the drawings to refer to the same or like parts. An exemplary embodiment of the container integrity security system of the present invention is shown in FIG. 1, and is designated generally throughout by reference numeral 10.

In accordance with the invention, the present invention is directed to a security system for monitoring shipping containers being transported by a plurality of cargo transport vehicles. Each cargo vehicle transports at least one shipping container. The system includes a plurality of container locking seals. Each locking seal is configured to be removably coupled to one freight shipping container to thereby seal the freight shipping container when in a coupled position. Each container locking seal includes at least one anti-tamper sensor and a seal transceiver. The system also includes a plurality of state recorders. Each state recorder is disposed in one cargo transport vehicle. Each state recorder includes a recorder communications system configured to communicate with each seal transceiver disposed in the cargo transport vehicle. The state recorder also includes a data storage module configured to store data received from each locking seal disposed in the cargo transport vehicle. A container alarm monitoring system (CAMS) is in communication with each of the plurality of state recorders in the system and at least one existing network. The CAMS is configured to receive data from each of the plurality of state recorders and notify at least one enforcement entity via the at least one network in the event of an alarm condition.

The present invention is directed to an intermodal threat identification, detection, and notification (ITIDN) transportation security system. As such, the present invention is applicable to all transportation modalities including air, rail, truck, ship, barge and bus transport modes. The instant security system provides inexpensive means for monitoring each shipping container and provides governmental and law enforcement agencies with the means to respond, in real-time, to cargo theft, piracy, and/or terrorist acts.

As embodied herein, and depicted in FIG. 1, an overview diagram of the ITIDN transportation security system in accordance with the present invention is disclosed. A typical scenario is depicted in FIG. 1. A plurality of commercial ships are in transit towards one or more of the ports disposed along the eastern seaboard of the United States. Each ship is being monitored and tracked using security system 10. Referring to the Detail View in FIG. 1, each ship 12 is carrying a plurality of shipping containers 14. Referring to detail view 1A, each of the containers 14 on board ship 12 is equipped with a locking bar 140. Locking bar 140 is secured with locking seal 20 of the present invention. Each locking seal 20 communicates with container state recorder (CSR) 30 which is disposed at a convenient location on board ship 12. When locking seal 12 is tampered with, an alarm signal is generated and transmitted to CSR 30. As shown by the concentric circles surrounding ship 12, when any of the locking seals 20 on ship 12 generate an alarm signal, the on-board CSR 30 transmits an alarm message to container alarm monitoring system (CAMS) 40 by way of satellite 16. As discussed in greater detail below, the alarm message includes the location of the cargo vehicle, in this case a ship, the identity of ship 12, the time and date the alarm was generated, and a description of the alarm itself. In response, CAMS 40 generates a law enforcement notification message which is transmitted to all relevant authorities. The law enforcement notification message relays all of the above described data, and may also include the port of origin, and a history of all of the ports visited by ship 12. CAMS is also configured to generate alarms based on route deviations, unscheduled delays, and other alarm criteria, as described in detail below.

Those of ordinary skill in the art will recognize that the present invention is not limited to the above scenario. The present invention may be deployed in cargo vehicles such as aircraft, barges, trains, buses, and trucks/trailers.

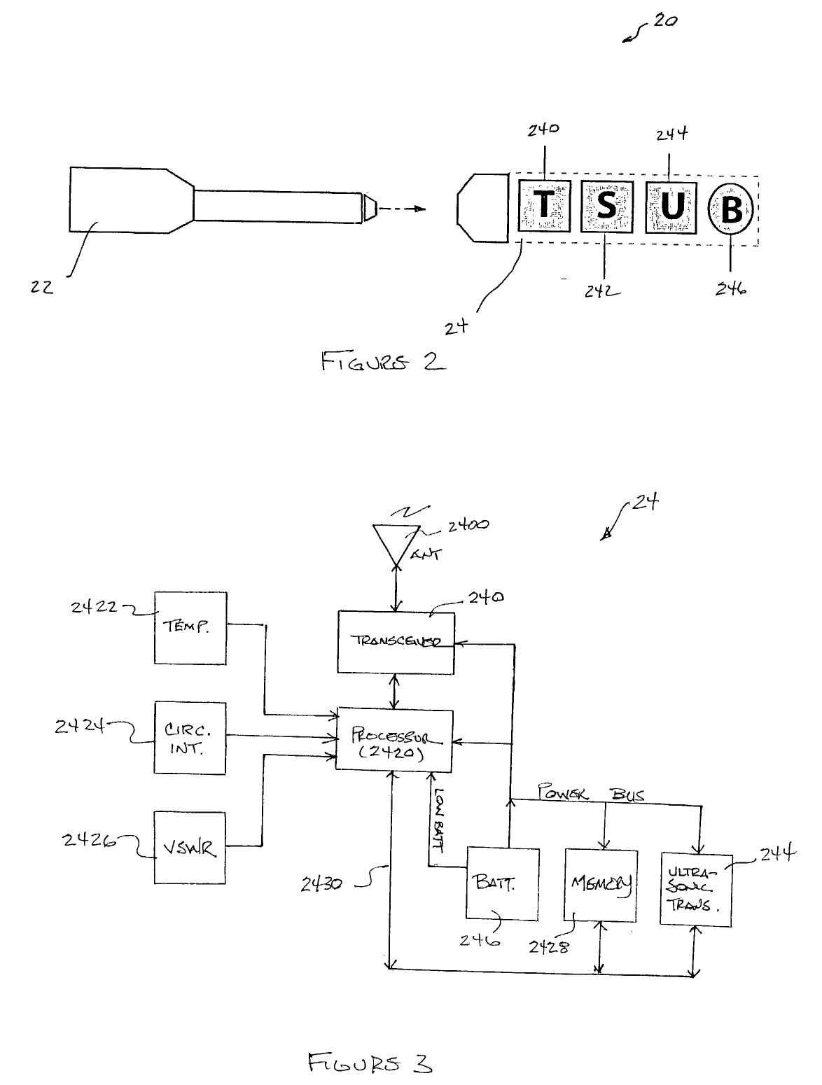

As embodied herein and depicted in FIG. 2, a cross-sectional view of the intelligent container locking seal 20 depicted in FIG. 1 is disclosed. Locking seal 20 includes locking pin 22 and cylinder 24. Referring back to the Detail View 1A in FIG. 1, pin 22 is inserted through locking bar 140. The seal is locked in place when pin 22 is inserted into cylinder 24 until a distinct clicking sound is heard. The seal may be unlocked electronically by way of a command from CSR 30. Referring back to FIG. 2, cylinder element 24 includes communications transceiver 240, sensor suite 242, ultra-sonic transducer 244, and battery 246.

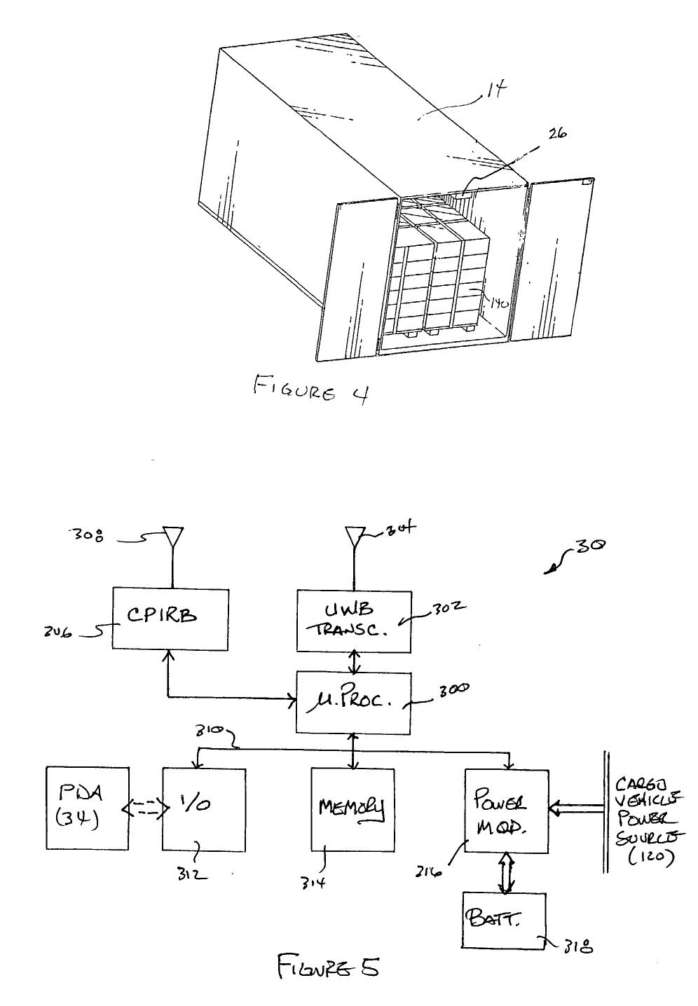

Referring to FIG. 3, a block diagram of cylinder 24 is disclosed. Cylinder 24 includes the electronics that provide locking seal 20 with its intelligence. Sensor suite 242 (FIG. 2) includes temperature sensor 2422, internal circuit interrupt sensor 2424, and voltage standing wave ratio (VSWR) sensor 2426, all coupled to processor 2420. Processor 2420 is also coupled to memory 2428, transceiver 240, and ultra-sonic transducer 244. Processor 2420 also monitors battery 246 for battery level. Battery 246 may be implemented using a lithium ion power source.

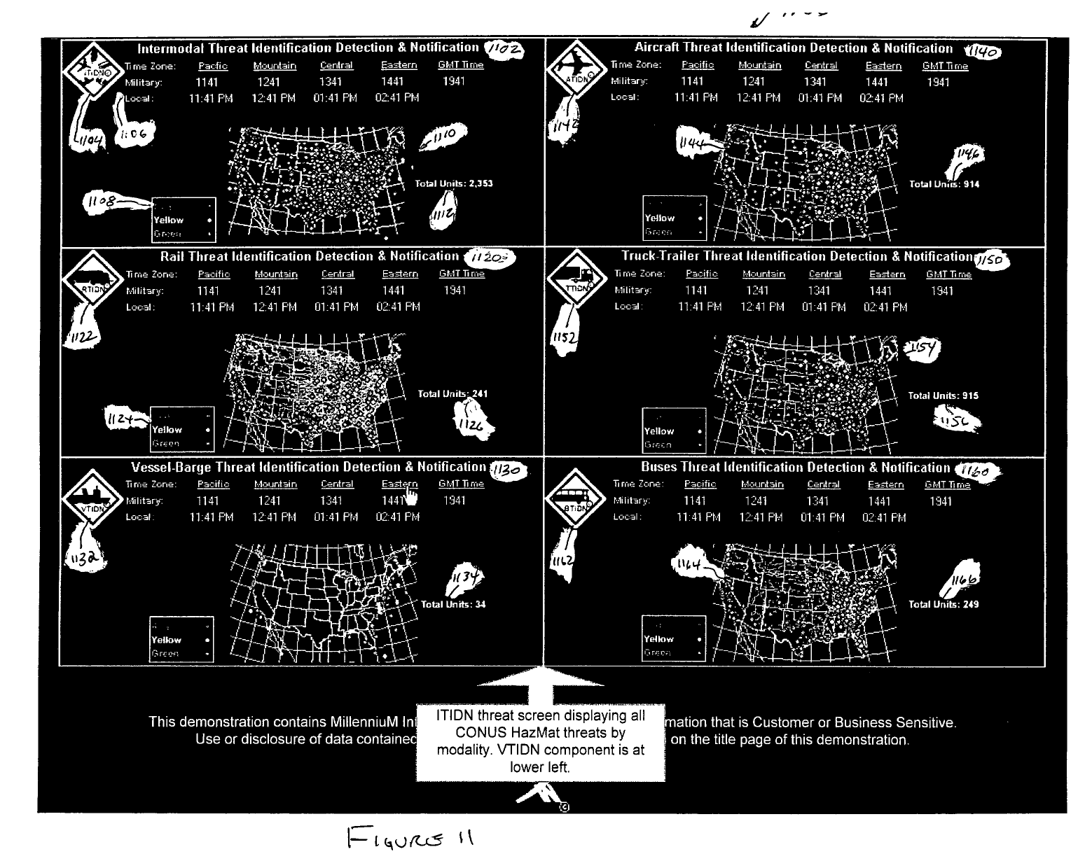

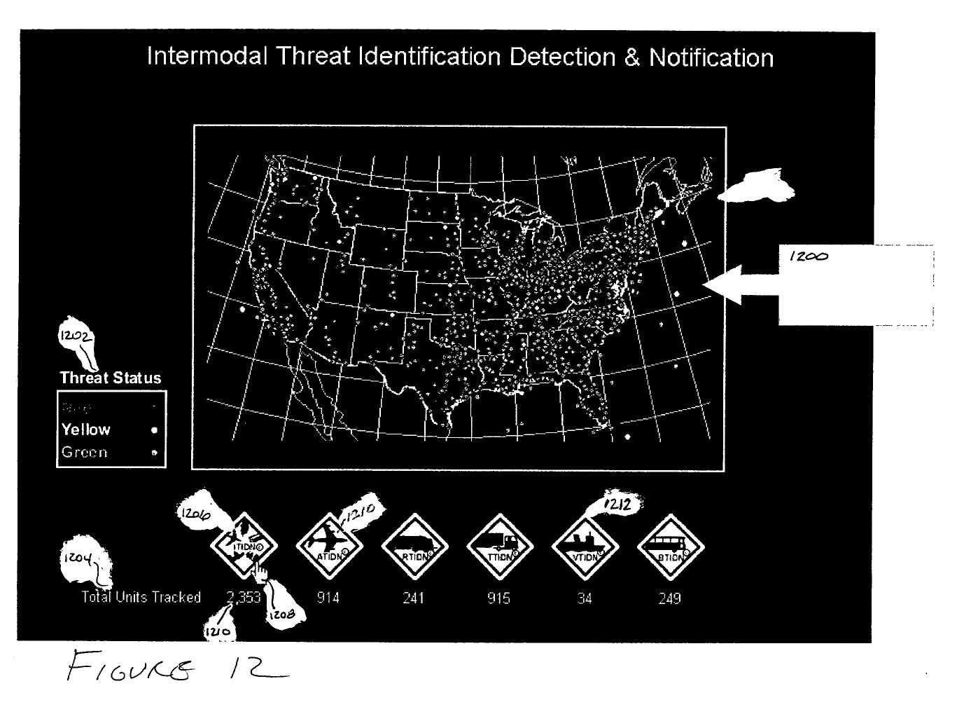

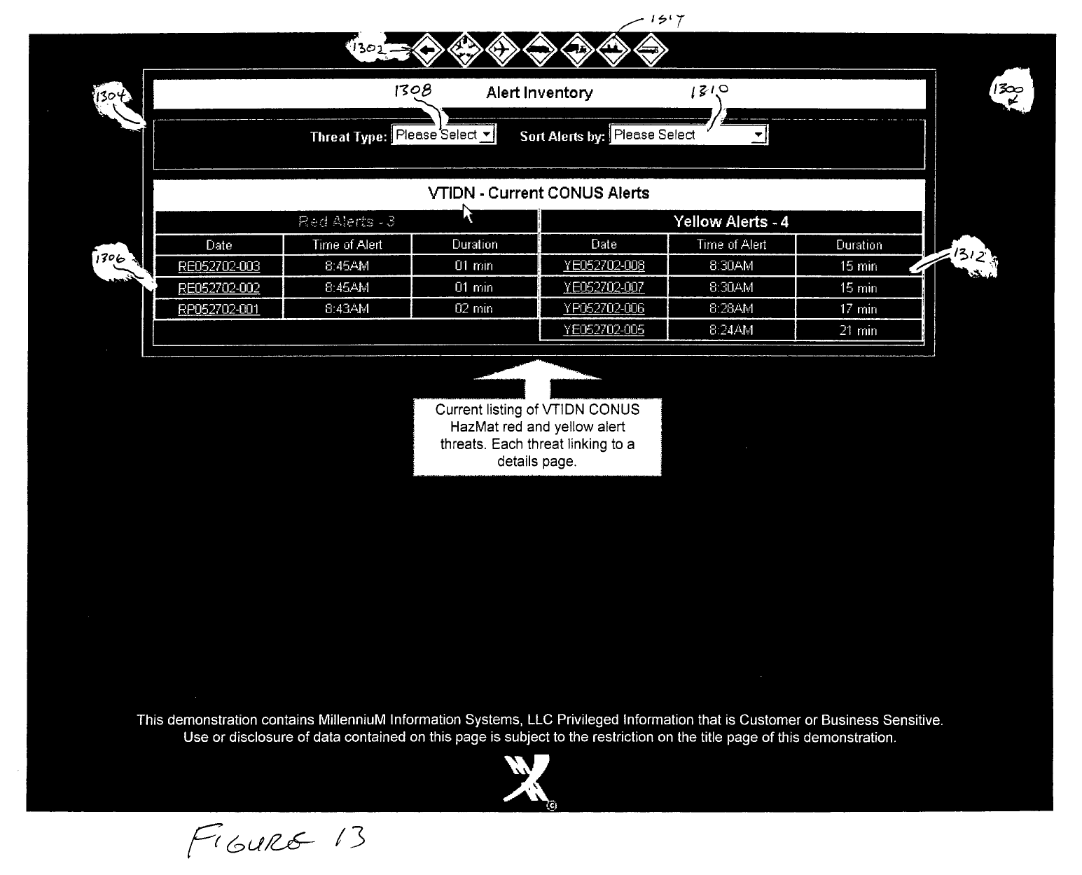

During transmission operations, processor 2420 conditions the sensor inputs and provides transceiver 240 with a formatted message packet. The transmitter in transceiver 240 modulates the message packet. The signal is transmitted from omni-directional antenna 2400. On the receive side, transmissions from CSR 30 are directed into the transceiver 240 from antenna 2400. After demodulation, processor 2420 processes CSR message packets. The structure of the message packets will be described in greater detail below in the discussion of FIGS. 10A-10D.

Temperature sensor 2422 generates a temperature alarm when it senses temperatures that are outside of the range of temperature between −50 C and +80 C. Those of ordinary skill in the art will recognize that the parameters of the temperature range may be modified. For example, the temperature range may be limited to 0 C-+80 C, or expanded to comply with strict military standards.

The circuit interrupt sensor 2424 includes a circuit designed to detect whether the physical integrity of the seal is intact. For example, when the body of seal 20 is cut, the circuit is interrupted and sensor 2424 generates an alarm signal.

VSWR sensor 2426 detects the presence of relatively high VSWR. A high VSWR is indicative of the presence of a jamming signal or a signal from a counterfeit CSR. When the VSWR exceeds a predetermined level, an alarm signal is generated. While the transceiver 240 is relatively immune to jamming or other electromagnetic signals, the presence of a high VSWR may signal tampering.

It will be apparent to those of ordinary skill in the pertinent art that processor 2420 may be of any suitable type depending on the functionality and sophistication of the firmware resident in memory 2428. Essentially, processor 2420 may be implemented using the lowest cost components on the market. Those of ordinary skill in the art will recognize that 4 bit, 8 bit, 16 bit, or 32 bit machines can be used to implement processor 2420, depending on speed, cost and other design considerations. Those of ordinary skill in the art will also recognize that processor 2420 may also be implemented using an application specific integrated circuit (ASIC), or a processor and ASIC in combination.

If an alarm signal is generated by sensor suite 242, processor 2420 is configured to activate ultra-sonic transducer 244. Ultra-sonic transducer 244 generates an acoustic tone in a frequency range between 25-28 kHz (nominal). At these frequencies the tone is audible to canines, but not audible to humans. The transducer can only be deactivated by CSR 30. In another embodiment, the transducer is phase modulated to transmit I-seal alarm data to hand-held receiver units which are configured to detect and store the data conveyed by the inaudible acoustic signal.

It will be apparent to those of ordinary skill in the pertinent art that any suitable RF wireless transceiver may be used to implement transceiver 240 of the present invention depending on cost, choice of modulation technique, or other technological issues. Transceiver may also be implemented using well-known passive RF technology that employs passive resonant circuits.

In one embodiment, transceiver 240 is implemented using ultra-wide band (UWB) technology. Essentially, the UWB transmitter modulates a coded timing signal with the information signal. The coded timing signal may be generated by modulating a PN coded signal with a periodic timing signal. The information signal may be used as the modulating signal itself, or the information signal may be used to modulate a subcarrier, which in turn, modulates the PN coded signal. At any rate, the transmitter emits Gaussian monocycle pulses, or cyclets, that have an average pulse-to-pulse interval. However, the actual intervals between pulses are varied from pulse to pulse by the aforementioned information component and psuedo-random code. Thus, the transmitter modulates the information by precisely positioning each pulse in the time domain by changing the pulse repetition interval as a function of the modulating information. Thus, each bit of information is represented by a pulse train. Further, by moving the position of the pulses in the time domain, the energy of the train is distributed over a wide range of frequencies.

In order to detect the information contained in UWB transmissions, the receiver must know the exact pulse sequence used by the transmitter. The UWB receiver typically includes a cross-correlator coupled to the antenna 2400, a decode source corresponding to the PN code employed by the transmitter, and an adjustable time base. The adjustable time base provides a periodic signal that includes a train of template signal pulses. The template signal pulses have waveforms substantially equivalent to each pulse of the received signal.

One benefit of UWB communications systems is that they do not require an assigned spectrum because transmissions are sent across an ultra wideband, the power level at any one frequency being too low to affect users assigned that frequency. UWB transceivers also use substantially less power than conventional wireless systems. Further, because Gaussian monocycle pulses are continuous wave transmissions, they are not affected by canceling due to multi-path. UWB transmissions are very secure because the transmitter emits millions of low-power monocycles per second in the psuedo-random manner described above. Because of the psuedo-random nature of UWB timing schemes, UWB is substantially immune to eavesdropping, interference, and jamming. For a receiver tuned to a particular frequency, UWB transmissions appear to be noise. UWB transceivers are also very compact, making the technology ideal for use in locking seal 20.

Reference is made to U.S. Pat. Nos. 6,031,862, 5,687,169, 5,677,927, and 5,363,108, which are incorporated herein by reference as though fully set forth in their entirety, for a more detailed explanation of UWB communication systems.

Referring to FIG. 4, a three dimensional view showing the placement of an NBC sensor suite 26 within a container 140 is disclosed. In this embodiment, sensor 26 is configured to detect the presence of nuclear, biological, and/or chemical materials/agents. Sensor suite 26 is also equipped with a transmitter configured to communicate with transceiver 240 in locking seal 20.

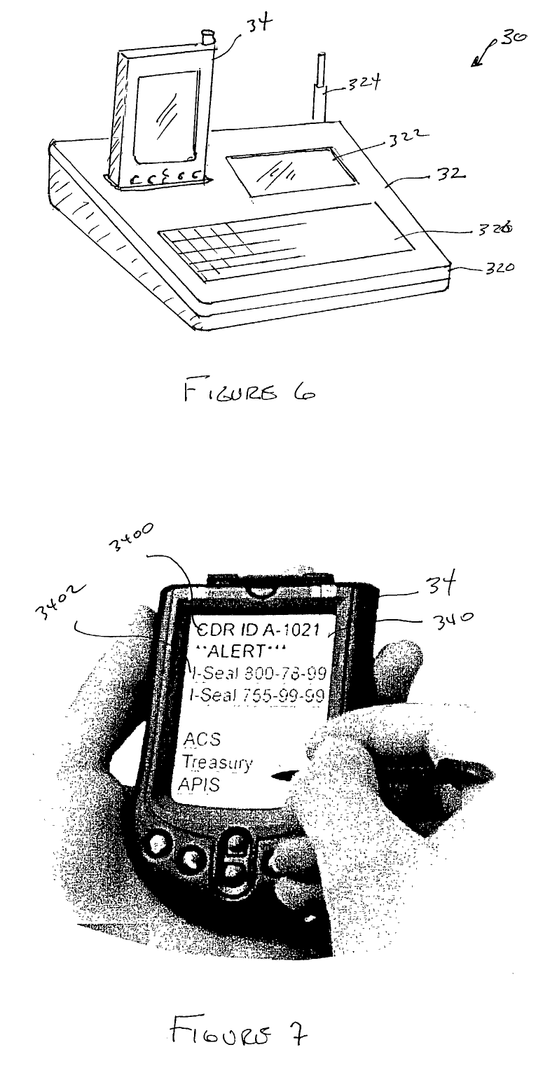

As embodied herein and depicted in FIG. 5, a block diagram of the container state recorder (CSR) 30 depicted in FIG. 1 is disclosed. CSR 30 includes processor 300 which is coupled to I/O unit 312, memory unit 314, and power module 316 via an internal bus structure 310. Processor 300 is also coupled to transceiver 302 and container position intrusion reporting beacon (CPIRB) 306. Transceiver 302 is adapted to communicate with transceiver 240 disposed in locking seal 20. CPIRB 306 includes a satellite transceiver that is configured to transmit and receive packets to/from CAMS 40, via a secure satellite communications channel. In one embodiment of the present invention, CSR 30 includes a hand-held personal digital assistant (PDA) device 34, which is coupled to I/O unit 312.

Power module 316 is adapted to be operatively coupled to the cargo vehicle power source. In the event that this power source is interrupted, power module 316 is configured to switch over to battery 318 power. The interruption is detected by processor 300, and an alarm message is transmitted to CAMS 40. The alarm message identifies the ship (or other vehicle), the location of the ship, the date and time, and the alarm event, e.g., loss of ship's power.

It will be apparent to those of ordinary skill in the pertinent art that modifications and variations can be made to microprocessor 300 of the present invention depending on cost, availability, and performance requirements. In one embodiment, microprocessor 300 is an off-the-shelf VLSI integrated circuit (IC) microprocessor manufactured by Intel, AMD, Motorola or some other such IC manufacturer that is chosen based on the aforementioned criteria. Those of ordinary skill in the art will also recognize that processor 20 can also be implemented using application specific integrated circuits (ASIC), or by a combination of an off-the-shelf processor and ASIC. Those of ordinary skill in the art will also recognize that processor 300 may also be implemented using a single RISC processor.

Memory 314 may be of any suitable type, but by way of example, memory 314 includes a read/write random access memory (RAM) used in data processing and data I/O, and a programmable read only memory for storing programming instructions used by processor 300, and for storing a CSR identifier that uniquely identifies CSR 30. One of ordinary skill in the art will recognize that the memory used to store the programming instructions may be implemented using a DRAM, PROM, EPROM, EEPROM, a hard drive, diskettes, a compact disk device, or any other computer readable medium.

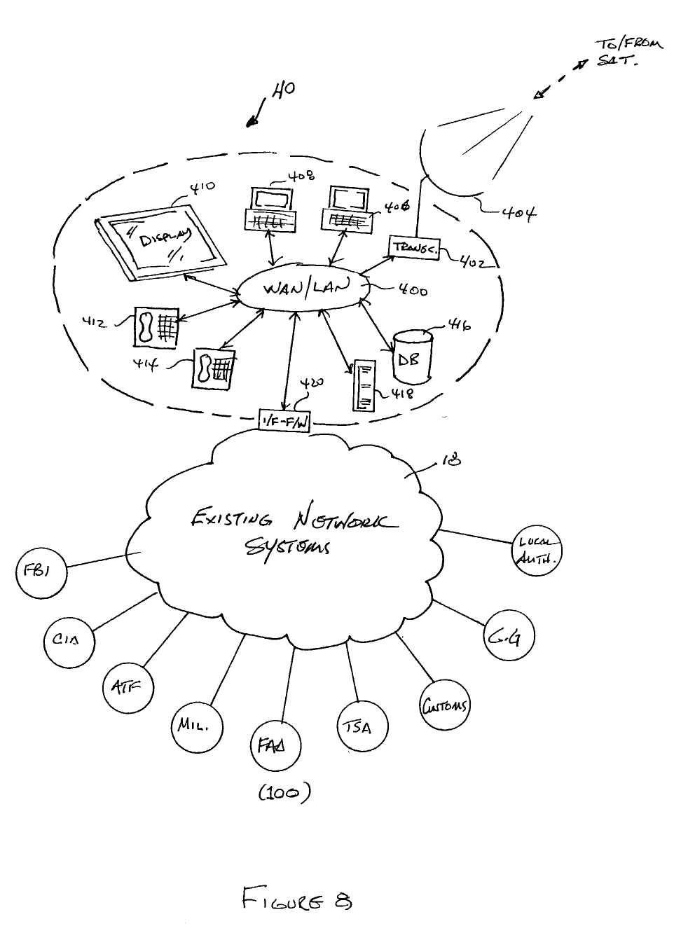

I/O unit 312 includes circuitry adapted to drive the CSR user interface. The user interface may include a display and a data input device. In one embodiment, the display includes a liquid crystal display device capable of displaying menu information, alarm status, container seal programming instructions, or any other information that can be graphically displayed. The data input device may also include a keyboard for data entry and programming functions. In yet another embodiment, I/O unit 312 supports a connector that mates with a connector disposed on a personal digital assistant (See FIGS. 6-7). All I/O operations may be performed using the PDA. I/O unit 312 may also be configured with a circuit suitable for recharging PDA 34.

It will be apparent to those of ordinary skill in the pertinent art that modifications and variations can be made to CPIRB 306 of the present invention depending on the satellite system interfacing CPIRB 306, but there is shown by way of example, an Emergency Position Information Reporting Beacon (EPIRB) that is customized and repackaged into a form factor suitable for the instant application. CPIRB 306 includes a satellite transceiver that is configured to communicate with DOD, Coast Guard, Law Enforcement, and/or Commercial frequencies. CPIRB 306 is also configured to obtain positional information using GPS.

Referring to FIG. 6, a three dimensional view showing the form-factor of the CSR 30 in accordance with one embodiment of the present invention is disclosed. In this embodiment, CSR 30 includes a base module 32 and hand-held PDA device 34. Base module 32 is equipped with display 322 and input device 326, disposed in housing 320. Input device 326 may include a keyboard, a computer mouse or a trackball device. Base module includes power module 316 coupled to cargo vehicle power. Base module 32 may also include CPIRB module 306, processor 300, and memory 314. In one embodiment, UWB transceiver 304 is disposed in PDA device 34. PDA device 34 may also be equipped with a bar code scanner configured to read bar codes disposed on individual locking seals or containers during a data entry mode. Referring to FIG. 7, PDA 34 allows personnel to be mobile, having access to CSR 30 while physically inspecting the cargo. User interface 340 conveniently displays any alerts 3400, in addition to identifying (3402) the locking seals generating the alerts.

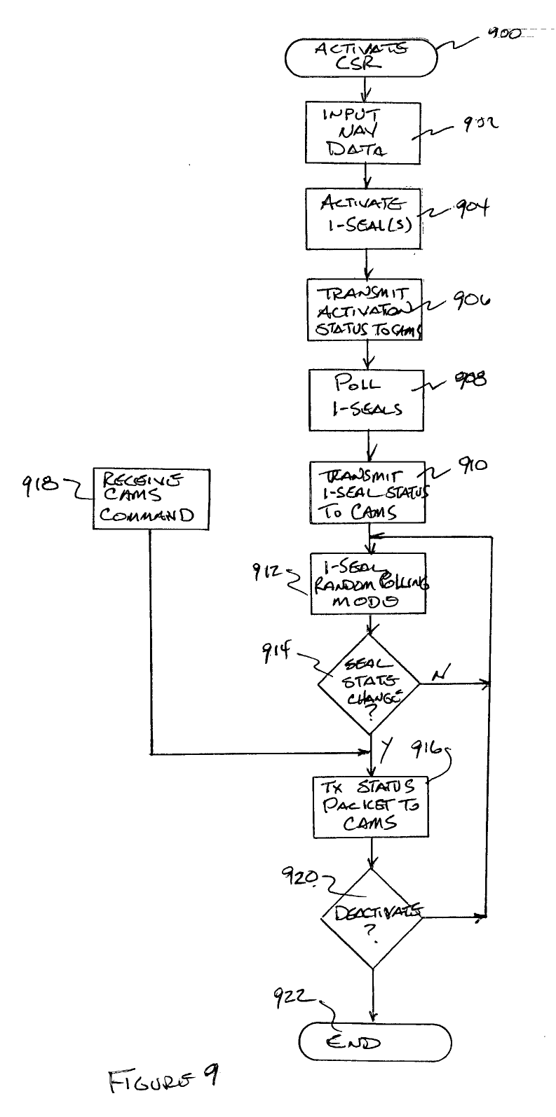

As embodied herein and depicted in FIG. 8, a diagrammatic depiction of the container alarm monitoring system (CAMS) 40 depicted in FIG. 1 is disclosed. CAMS 40 provides a distributed computing system that includes alarm data collection and alarm analysis, tactical management, law enforcement notification and provisioning, and display. CAMS 40 includes a plurality of computer workstations (406, 408) interconnected via local area network (LAN) or a wide area network (WAN) 400. CAMS 40 also includes dynamic command and control room displays 410, which are also coupled to LAN/WAN 400. CAMS 40 includes a plurality of telephones 412 and 414. The computing power may be disposed in server 418 or other computing devices not shown in FIG. 8. Database 416 may be used to store cargo vehicle routes and schedules, in addition to historical data.

CAMS 40 is coupled to existing network systems 18 via secure network interface 420, allowing CAMS 40 to communicate with various law enforcement and governmental authorities (100). CAMS 40 also includes satellite communications transceiver 402. Transceiver 402 and antenna 404 are configured to communicate with CSRs 30 deployed globally via satellite 16 (see FIG. 1).

Computer workstations 406, 408 may be of any suitable type, but there is shown by way of example a networked work station computer having a display device and an input device. The display may use a cathode ray tube (CRT), liquid crystal display, active matrix display, or plasma display, to display information to the user. The input device may be implemented using a keyboard that includes alphanumeric, control, and function keys. The user input device may also employ cursor control, which may be implemented using a mouse, a trackball, or cursor direction keys. Cursor control is typically employed to communicate direction information and command selections to a processor, and for controlling cursor movement on the workstation display. Cursor control may also be used to control cursor movement on control room displays 410. In one embodiment, the work station computers and LAN equipment may be based on technology provided by SUN Microsystems. Work station computers may also be implemented by networking personal computers, which are manufactured by a host of companies including IBM, Dell, Compaq, Apple and etc.

Workstations 406, 408 also include a communication interface that couples the workstation to LAN/WAN 400. The communication interface may be implemented using a local area network (LAN) card (e.g. for Ethernet™ or an Asynchronous Transfer Model (ATM) network) to provide a data communication connection to a compatible LAN 400. Wireless links can also be implemented. In any such implementation, communication interface is configured to transmit and receive electrical, electromagnetic, or optical signals that carry digital data streams representing various types of information. Personnel may access CAMS 40 from remote locations. In this instance, remote computers may be equipped with a communication interface that employs a digital subscriber line (DSL) card or modem, an integrated services digital network (ISDN) card, a cable modem, or a telephone modem. Remote computers must also be equipped with encryption software.

LAN/WAN 400 is implemented as a packet switched network interconnected by a common network protocol. Because of the secure nature of system 10, LAN/WAN may be implemented as a private intranet, or a private enterprise network. The transmission media used to interconnect LAN/WAN 400 may also be of any suitable type depending on cost and/or other design issues. The transmission media may include coaxial cables, copper wire and fiber optic cables. Transmission media may also be implemented using acoustic, optical, or electromagnetic waves, such as those employed by wireless and infrared (IR) data communications systems.

The database 416 employed by CAMS 40 may be of any suitable type, depending on capacity requirements. For example, database 416 may be implemented using technology provided by ORACLE. Data may be stored using any suitable type of computer readable media. Common forms of computer-readable media include, for example, floppy disk, flexible disk, hard disk, magnetic tape, any other magnetic medium. The media may include RAM, ROM, PROM, EPROM, E²PROM, FLASH-EPROM, or any other memory chip or cartridge. The media may also include optical media such as CD-ROM, CDRW, DVD, or any other optical medium, such as punch cards, paper tape, optical mark sheets, any other physical medium with patterns of holes or other optically recognizable indicia.

Telephone sets 412, 414 may also be of any suitable type. In one embodiment, the telephone sets are implemented using internet protocol (IP) telephone sets. In another embodiment, the telephones 412 and 414 may be implemented using traditional telephone sets. Traditional telephone sets may be used in both the PSTN or in an IP network. Traditional telephones may be connected to an IP network through traditional telephone switching equipment, such as PBXs or telephony gateways. IP phones may be connected directly to the Internet through a local area network or by modem connection through an Internet Service Provider (ISP).

In one embodiment, the CAMS telephone system is integrated into the LAN/WAN 400, and voice communications are converted into a digital format and packetized for transmission over the network.

Interface 420 may include gateways, routers and/or other suitable equipment used to interface existing network systems. Existing networks may include Public Switched Telephone Networks (PSTN), packet switched networks such as the Internet, or they may be hybrids that include PSTNs and packet switched networks. PSTN are a circuit switched networks such as those based on Signaling System No. 7 (SS7). Callers are connected by a circuit maintained during the entire duration of the call. Packet switched networks do not employ circuits maintained during the entire duration of the call. Packet switched networks are adapted to carry various types of media, such as voice, data, and audio or video streams by individually transmitting discrete packets of data that may or may not traverse the same physical transmission path. Hybrid telecommunications network include at least one PSTN coupled to a packet switched network by a gateway. Interface 420 of the present invention also includes appropriate security mechanisms, such as fire walls, encryption, and security tunnels, to protect the network elements of CAMS 40 from hacking and/or spoofing.

CAMS 40 may also be distributed over two or more sites. In one embodiment, a PSTN may be employed to provide virtual private network (VNET) services for CAMS personnel. Each site would include a PBX. When a telephony circuit is established between the PBXs by way of PSTN switches, dial plan information, number translations, and all of the other call control data required to maintain the VNET is provided by the PSTN.

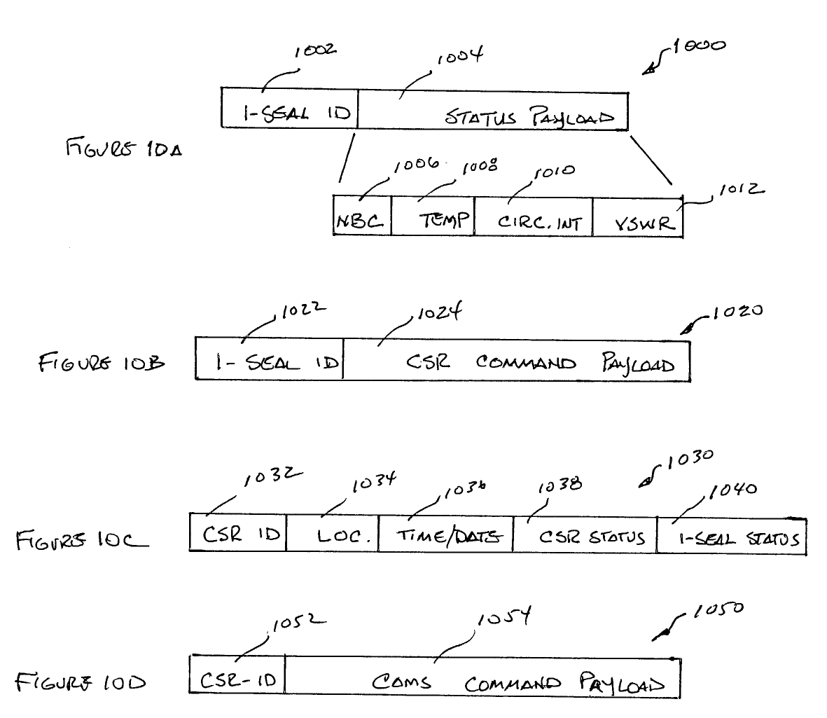

Referring to FIG. 9, a flow chart showing a method for monitoring container integrity in accordance with one embodiment of the present invention is disclosed. When a ship, aircraft, train, or any other type of cargo vehicle is loaded, the locking seals 20 are used to seal the containers and CSR 30 is activated. Immediately afterward, CSR 30 obtains a positional fix using GPS data and sends an activation transmission to each of the locking seals 20. In response, each locking seal 20 activates its RF transceiver 240 (See FIG. 2 and FIG. 3) and responds with a status message. CSR 30 processes the status messages and relays the activation status of each of the locking seals to CAMS 40 in a message packet, or series of packets. Next, CSR 30 polls each seal to obtain the alarm status of each seal. Again, this status is relayed to CAMS 40. These steps are performed to ensure that both CSR 30 and locking seals 20 are operational before the vehicle is underway. Subsequently, CSR 30 enters into a random poling mode and notes any locking seal status changes. If there are no status changes, CSR continues to randomly poll locking seals 20. If there is an alarm status change, CSR 30 transmits a status packet to CAMS 40. In step 918, CAMS 40 may direct CSR 30 to provide it with a status packet. This step may be performed for a number of reasons. For example, CAMS 40 is configured to store route and schedule data for ships, aircraft, trucks, trains, and buses. If the route and/or schedule is deviated from, CAMS may generate an internal alarm. This scenario is discussed in more detail below. In another scenario, CAMS 40 may determine that the last status message received from CSR 30 is stale and requires an up date. Steps 912-920 are performed continually until a deactivation command is received.

FIGS. 10A-10D show the data structure for each of the communication packets employed in the container integrity management system. In FIG. 10A, the data structure of packet 1000 sent from locking seal 20 to CSR 30 is disclosed. Packet 1000 includes seal identification field 1002, and seal status payload 1004. Payload field 1004 includes several sub-fields, such as NBC status field 1006, temperature status field 1008, circuit interrupt sensor status field 1010, and VSWR status field 1012. FIG. 10B shows the data structure of packet 1020 sent from CSR 30 to locking seal 20. Packet 1020 also includes a seal identification field. If this field does not contain the identifier stored in seal memory, locking seal 20 will not respond to CSR communication attempts. Packet 1020 also includes a CSR command payload. As described above, the suite of commands includes the seal activation command. CSR 30 may also request a status update from a particular seal during one of its polling modes, or by way of a request from CAMS 40.

Referring to FIG. 10C, the data structure for packets 1030 sent from CSR 30 to CAMS 40 is shown. The identification code for the particular CSR 30 is disposed in field 1032. Data corresponding to the location of CSR 30 is disposed in field 1034. The time and date is disposed in field 1036. The operational status of the transmitting CSR is disposed in field 1038. Among other things, CSR 30 indicates whether it is operating on ship's power, or on battery power. The field may be used to relay the status of individual components. Finally, locking seal status data, which includes alarm messages, are disposed in field 1040. FIG. 10D shows the data structure for packets 1050 sent from CAMS 40 to CSR 30. Packet 1050 includes a CSR identification field 1052. If field 1052 does not contain the identifier stored in CSR memory, CSR 30 will not respond to the communication attempt. Packet 1050 also includes a CAMS command payload. CAMS 40 may issue commands requesting more information in the event of an alarm or some other activity. For example, CAMS may interrogate CSR 30 at a higher rate if the CSR 30 indicates the cargo vehicle is deviating from its predetermined route, is in proximity to sensitive area, is experiencing an unscheduled delay, or if there are other conditions of concern.

Referring to FIG. 11, a graphical user interface that includes ITIDN threat display screen 1100 is shown. Those of ordinary skill in the art will recognize that the screen may be displayed on the CAMS command and control display or on workstation displays. Icons and menus may be selected using the keyboard or by cursor control, which may be implemented using a mouse, a trackball, or cursor keys.

Display 1102 includes the entire ITIDN environment, whereas each of the other screens (1120, 1130, 1140, 1150, and 1160) addresses each individual transportation mode. Referring to display screen 1102, the display is identified as the ITIDN display by display element 1104. Both military time and local time, by time zone, are provided by display element 1106. The threat status icon 1108 indicates that red dots are indicative of confirmed (red level) threats, yellow dots point to potential (yellow level) threats, and the green dots refer to all other normal traffic that is being tracked(green level). Map 1110 shows the position of each aircraft, vessel-barge, truck, and bus being monitored and tracked by system 10. Display element 1112 displays the total number of cargo vehicles being tracked and shown on map 1110.

As mentioned above, the other screens (1120, 1130, 1140, 1150, and 1160) addresses each individual transportation mode. Display 1120 is directed to rail threats, display 1130 is directed to vessel-barge threats, display 1140 is directed to aircraft threats, display 1150 is directed to truck-trailer threats, and display 1160 is directed to buses. Each of the display screens 1120-1160 have the same sort of categories depicted in screen 1102. For example icons 1122, 1132, 1142, 1152, and 1162 identify each of the display screens as rail, vessel-barge, aircraft, truck, and bus display screens, respectively. Each display screen includes a map of the continental United States (CONUS) and with the location and number of each train, vessel, aircraft, truck, and bus being displayed thereon.

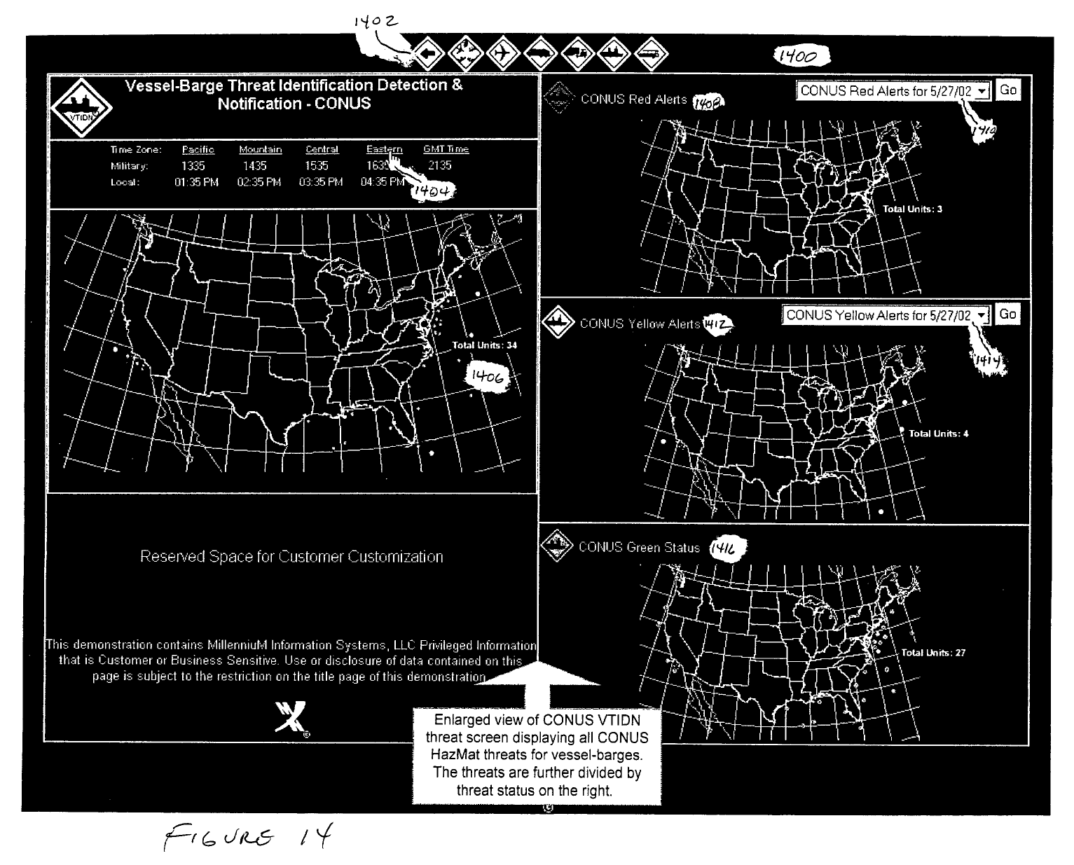

FIG. 12 shows a detailed ITIDN threat screen 1200. This display shows much of the same information displayed in screen 1102 with more detail. An identical threat status icon 1202 is employed. However, cursor icon 1208 can be moved, by way of mouse, trackball, or cursor keys, to move from display screen-to-display screen by clicking on a given change display screen icon(e.g. 1206, 1210, etc.). For example, if the user clicks on icon 1210, the aircraft threat identification detection and notification screen will be displayed. Similarly, if the user clicks on icon 1212, the vessel-barge threat identification detection and notification screen will be displayed.

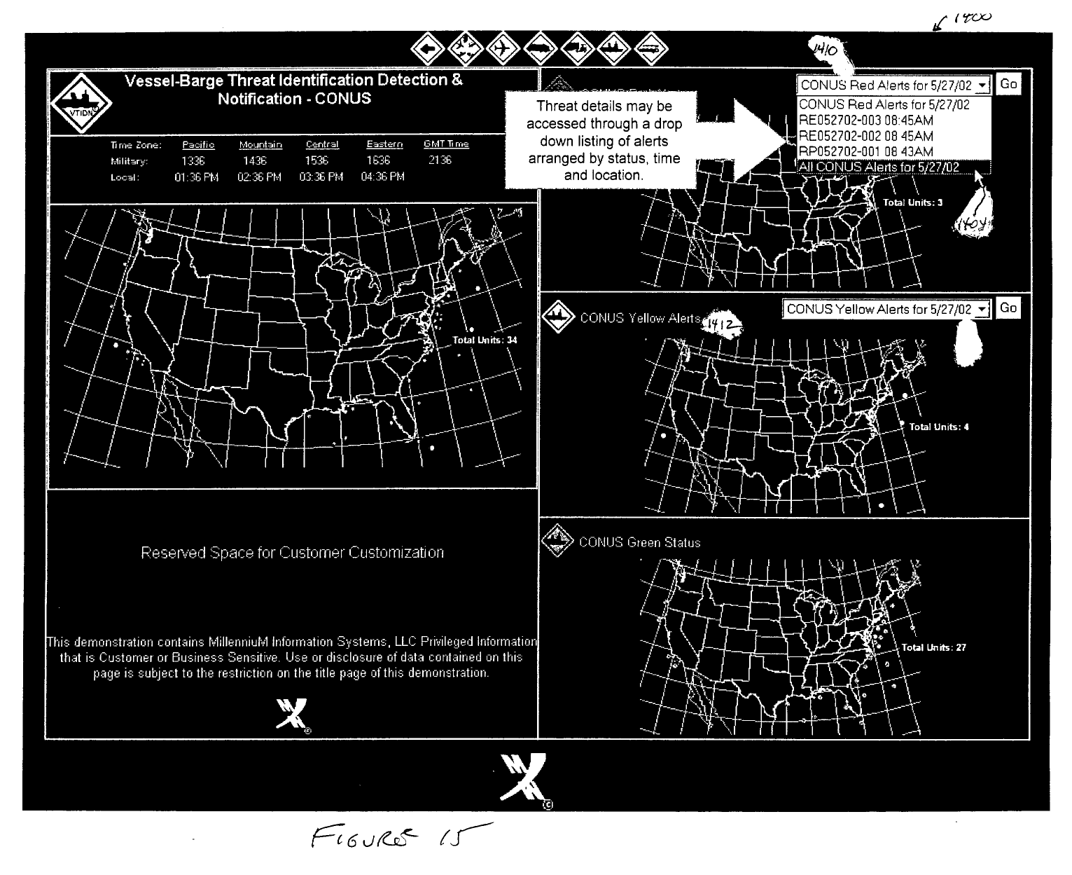

Referring to FIG. 13, an alert inventory screen 1300 is shown. Screen 1300 provides a suite of change display icons similar to icons 1206, 1210, and 1212 described above. For example, arrow icon 1302 allows a user to cycle through all of the display screens. Icon 1314 will direct the user to the vessel-barge display. Screen 1300 also includes an alert inventory window 1304 and current alert window 1306.

The alert inventory window 1304 of the display includes several pull-down menus. Pull-down menu 1308 allows the user to view the status of each of the threat types (rail, vessel, aircraft, and etc.). Pull down menu 1310 allows the user to sort each of the threat types by date, time, or other criteria. Current alert window 1306 displays the current status of both red and yellow level alerts for the selected threat type.

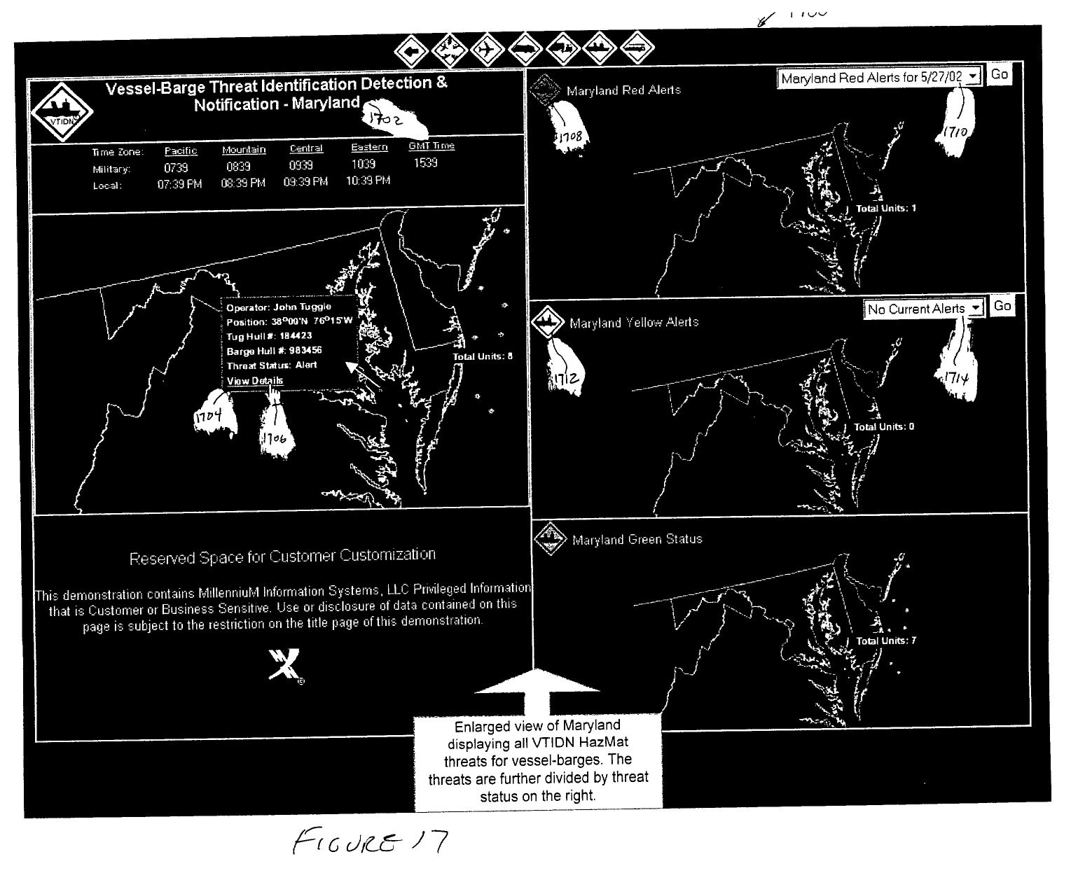

Referring to FIG. 14, a vessel-barge threat display screen is shown. Display screen 1400 also provides a suite of change display icons 1402 that may be actuated by cursor 1404. For example, arrow icon 1402 allows a user to cycle through all of the display screens. Cursor icon 1404 may also be used to access any page link displayed on screen 1400. For example, FIG. 14 shows cursor icon 1404 pointed at the word “Eastern,” which is a link to a map of the eastern time zone. When the cursor is clicked on this link, a detail screen showing only Eastern time zone activity is displayed (See FIG. 16).

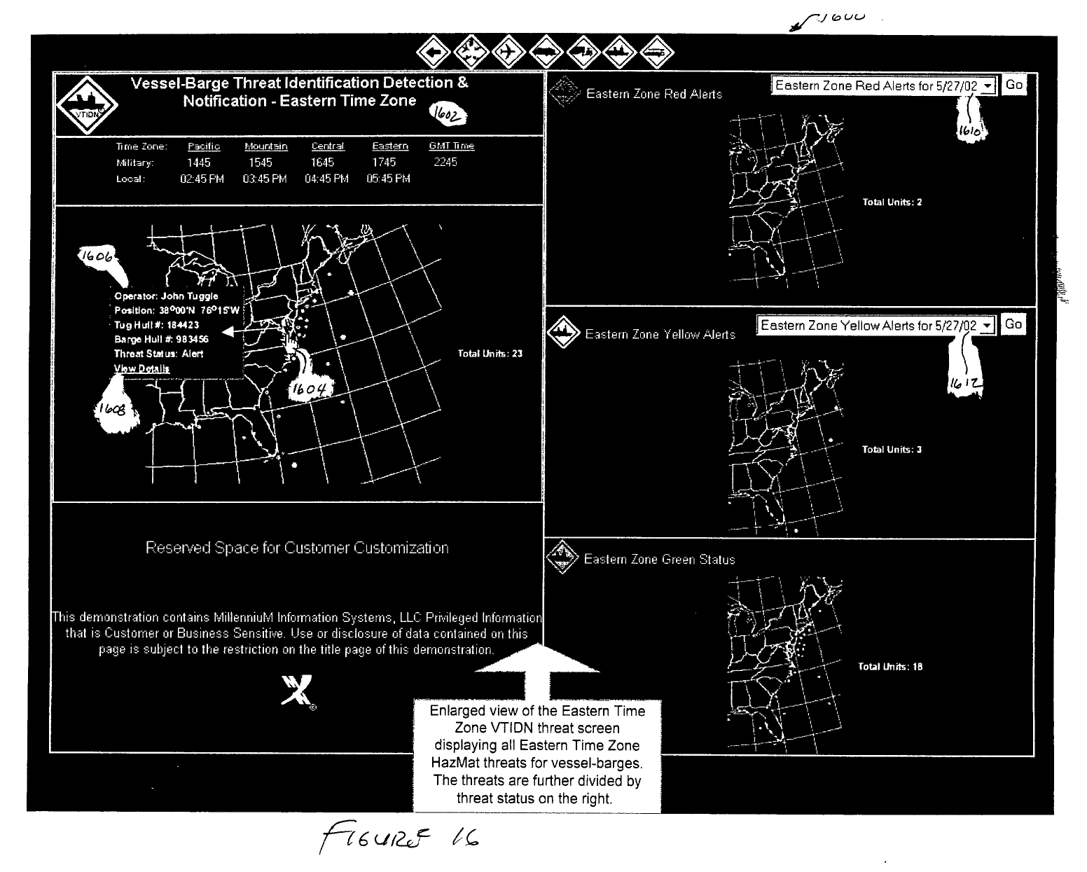

Display screen 1400 also includes map displays 1406, 1408, 1412, and 1416. Map display 1406 shows the location of all of the vessels/barges being tracked in U.S. waters. As shown, there are 34 units being tracked. Map display 1408 shows red-level units, map display 1412 shows yellow-level units, whereas map display 1416 shows green level units. Map display 1408 includes a pull-down menu 1410 that lists each red level alert. Map display 1412 also includes a pull-down menu 1414 that lists each yellow alert. Referring to FIG. 15, a detail view of pull-down menu 1410 is shown. As shown, pull-down menu 1410 shows threat details arranged by status, time, and location.

FIG. 16 is a display screen that shows the vessel-barge threat in the Eastern time zone. This display screen may be accessed by the “Eastern” link described above. In the scenario depicted in FIG. 16, a fuel barge loaded with diesel fuel is being tracked by the security system 10 of the present invention. The owners of the barge have provided the system with its point of origin (Norfolk), its destination (Dahlgren Naval Surface Weapons Center), and its intended route/schedule. This information is stored in CAMS database 416 (See FIG. 8) and used by CAMS to perform en route analyses. At the appointed time, the barge departs Norfolk, being pushed by a tug-boat that is also owned by the owners of the barge. One segment of the trip is a 75 mile leg from Norfolk to Smith Point, which is located at the southern shore of the confluence of the Potomac River and the Chesapeake Bay. This segment of the route should take about five hours to traverse. At the end of this portion of the trip, the barge is scheduled to turn northwest and enter the Potomac River. However, the barge does not follow the preregistered route. Instead, it continues north toward the Chesapeake Bay Bridge. During the trip, routine message packets, from the CSR disposed on the barge, relay the barge's location via the CPIRB satellite link. The CAMS server computer 418 (FIG. 8), or other CAMS computing resources, compare the barge location with the preregistered route and determines that the barge is off-course. An alarm is generated and displayed on CAMS command and control display and/or on a selected CAMS workstation.

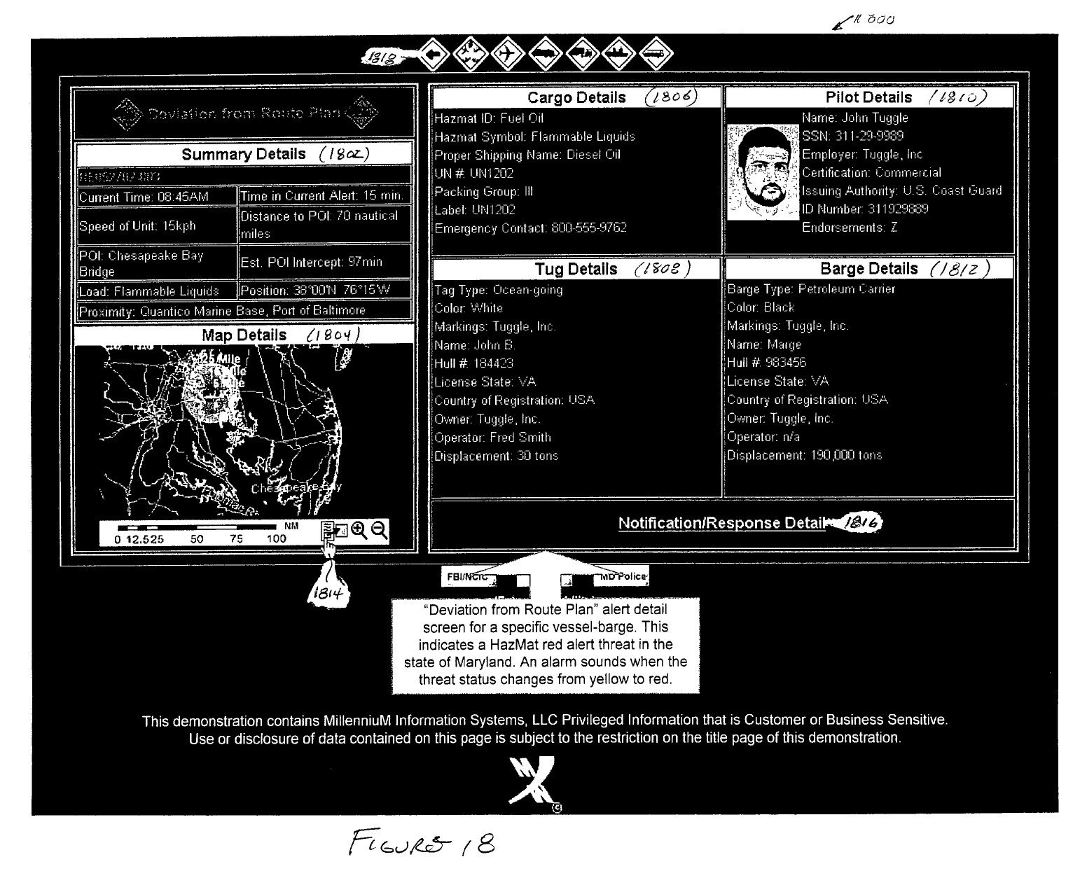

Referring back to FIG. 16, display screen 1600 includes two main windows containing Eastern time zone vessel/barge threat data. The right window includes three maps, one for red alert contacts, one for yellow alert contacts, and the last one for green status contacts. The red alert screen and the yellow alert screen provide pull-down menus 1610 and 1612 respectively. The left window includes a title icon 1602 which identifies the screen. Map 1606 displays all of the vessels/barges being tracked in the Eastern time zone. As shown, the user uses cursor icon 1604 to click on the red dot corresponding to the above described barge and window 1608 is displayed. Window 1608 provides the user with the name of the barge operator, the position of the barge, the hull number, and the threat status. Cursor 1604 may be used to click on individual States to show a State's vessel-barge threat and notification screen (e.g., See FIG. 17 for Maryland). Further, a “view details” link is provided at the bottom of the window.

Referring to FIG. 17, a detailed vessel-barge threat and notification screen 1700 showing the vessel/barge threats for Maryland is depicted. Screen 1700 has an identical format to that of screen 1600, in that it includes a right window that includes a map 1708 for red alert contacts, map 1712 for yellow alert contacts, and another map for green status contacts. The red alert screen and the yellow alert screen also provide pull-down menus 1710 and 1714 respectively.

The left window includes a title icon 1702 which identifies the screen. The left panel also includes a map that displays all of the tracked vessels/barges traversing Maryland waterways. Display 1700 also includes a detail window 1704 that provides the user with the name of the barge operator, the position of the barge, the hull number, and the threat status. Window 1704 also provides a “view details” link at the bottom of the window. When the user clicks on this link, the screen depicted in FIG. 18 is displayed.

FIG. 18 shows a vessel/barge detail page 1800 that includes a plurality of detail windows. Summary Details window 1802 provides the alert identifier (052702-003), current time, vessel speed, POI, the cargo, the distance to the POI, and the estimated time of POI intercept. Display 1800 also includes map details window 1804, cargo detail window 1806, tug detail window 1808, pilot detail window 1810, and barge detail window 1812. Tug detail window 1808 identifies the type of tub boat used to move the barge, physical information such as the color, name and hull number of the tug, the owner of the tug, the tug's operator and other pertinent information. Pilot detail window 1810 provides the tug pilot's name, social-security number, and other identifying information. Finally, barge detail window 1812 identifies the barge type, some of the physical properties of the barge, such as color, name, and hull number. Other pertinent information that may be useful to enforcement or interdiction entities is also provided.

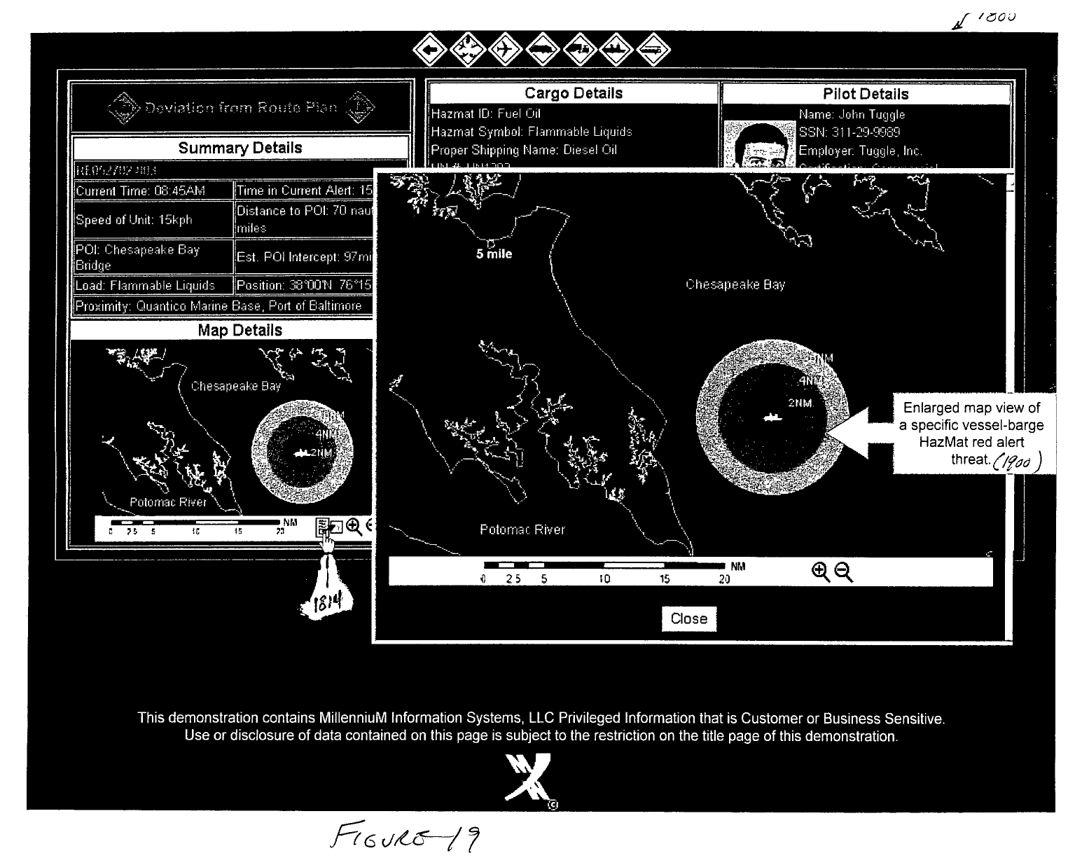

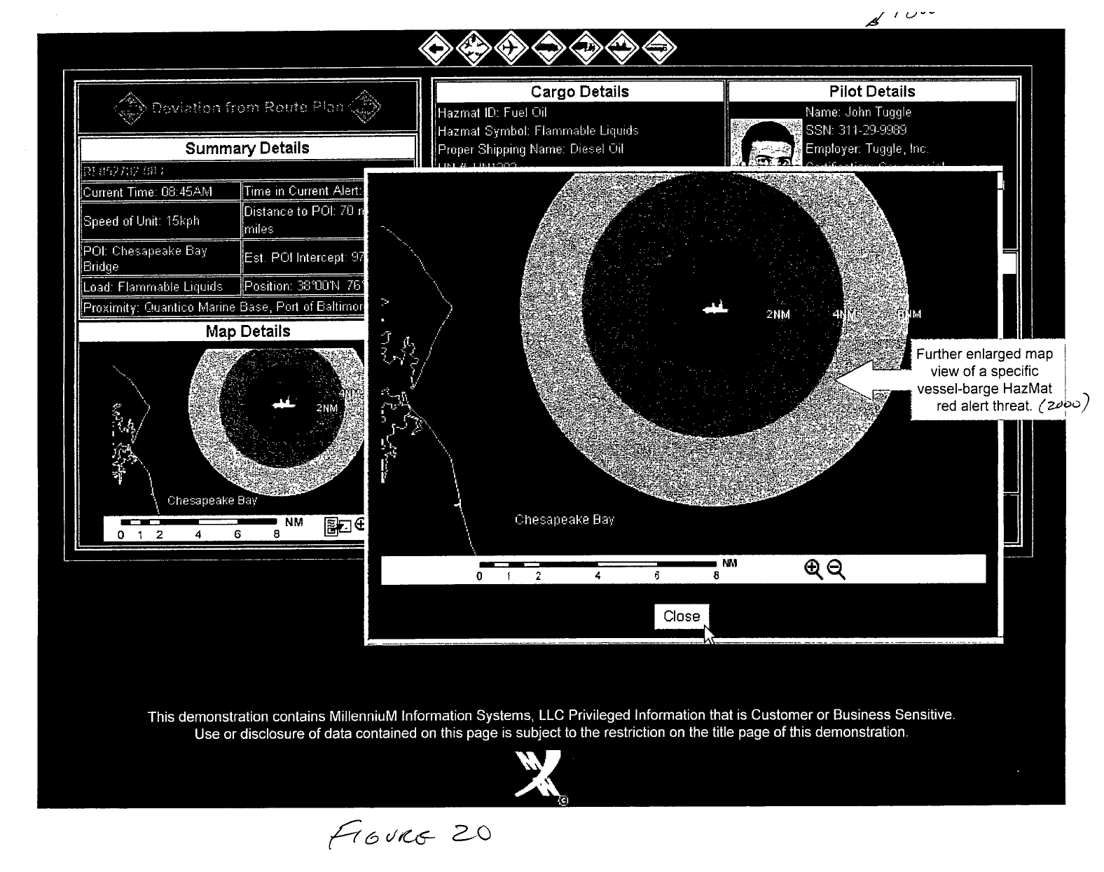

As shown, cursor icon 1814 is pointing at several icons which represent an enlarge map icon, zoom icon, and reduce map size icon. For example, by clicking on the enlarge map icon, an enlarged map view of the map depicted in window 1814 is obtained. FIG. 19 and FIG. 20 show enlarged map-views at various scales. Referring back to FIG. 18, cursor 1814 may be used to click on icon 1818 to move to another display screen, or to click on icon 1816 to obtain notification/response details.

Those of ordinary skill in the art will recognize that each of the screens described herein also apply to the aircraft mode, the rail mode, the truck-trailer mode, and to the bus mode.

FIG. 21 shows the law enforcement notification response detail screen 2100 referred to above. Law enforcement notification response detail screen 2100 includes Notification Response window 2104, Summary Detail window 2106, and Map Detail window 2108. Cursor 2102 may be employed to move to another display screen, as shown, or to obtain enlarged map views, as previously discussed. Notification Response window 2104 lists the agencies that were notified, the time of notification, the time the agency responded to the notification and the notification status. Summary Detail window 2106 provides the current time, speed of the vessel, POI identifier, a description of the cargo, and other pertinent information. Map Detail window 2108 shows the location of the vessel/barge under investigation.

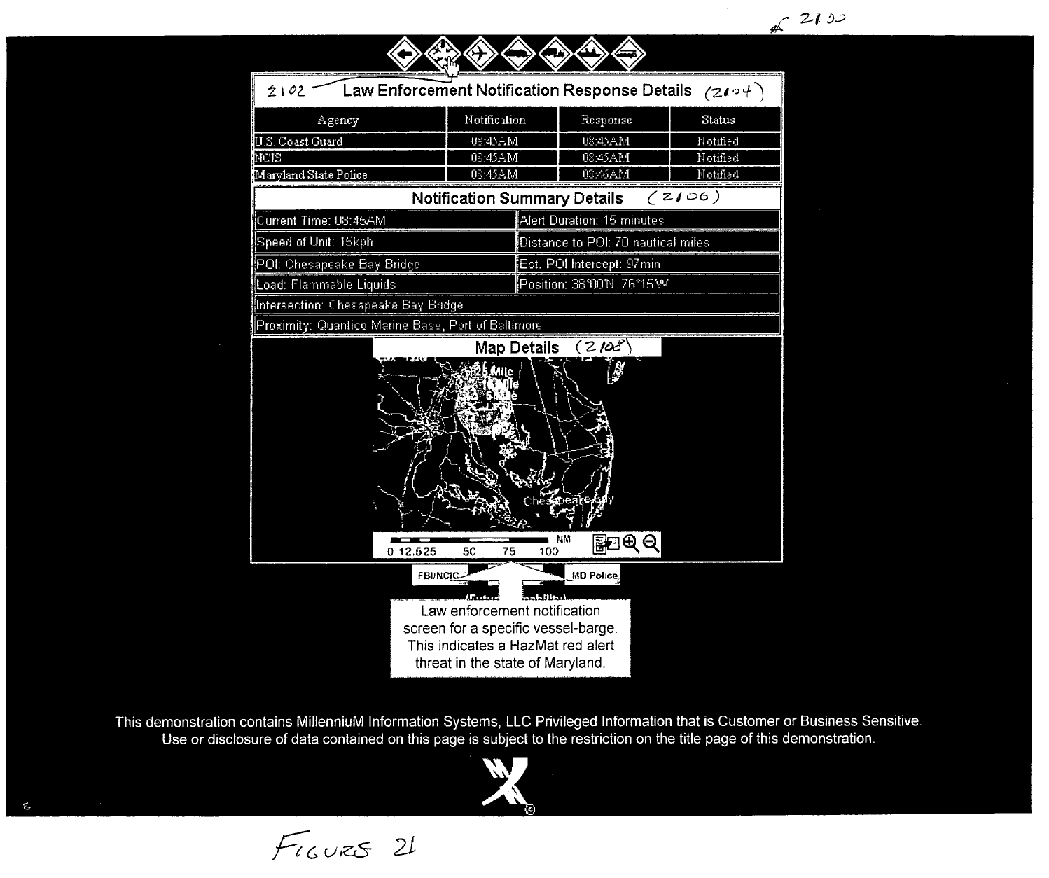

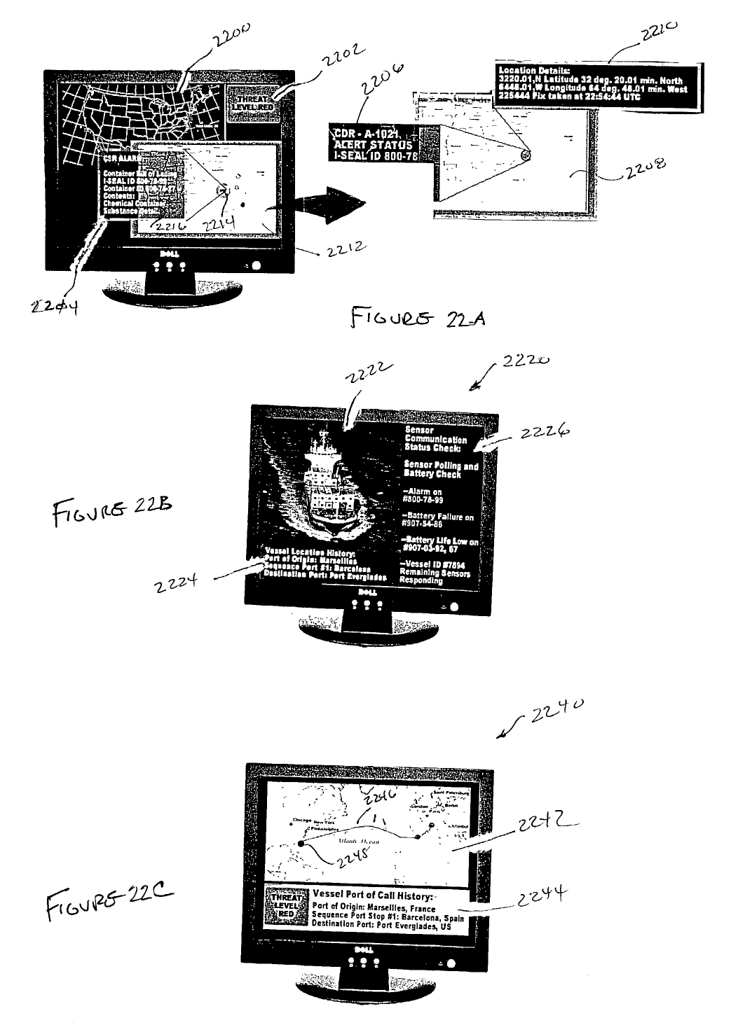

As embodied herein and depicted in FIGS. 22A-22C, an example of a graphical user interface that may be employed on the CAMS command and control display or on the work stations are used to illustrate another threat scenario. Those of ordinary skill in the art will recognize that the graphical user interfaces described above are equally applicable to the scenario that follows.

In this scenario, a ship originating from the port of Marseilles, France is en route to Port Everglades, U.S. During the voyage, the ship made one port stop, at Barcelona, Spain. While underway off the eastern coast of the U.S., one of the sensors in locking seal #800-78-99 detected an alarm condition. An alarm message is transmitted from CSR A-1021 to CAMS 40.

Referring to FIG. 22A, display screen 2200 is identical to the vessel/barge map display described above ( e.g., See FIG. 14). Window 2202 indicates that the alarm is considered a red-level threat. As described above with respect to FIGS. 18-20, window 2212 provides an enlarged map view. The user obtains CSR alarm detail window 2204 by clicking on the vessel icon 2214 displayed on the map. Window 2204 reveals that locking seal #800-78-99 corresponds to chemical container ID No. 800-78-27. The user may click on substance detail icon 2216 to determine the contents of the container. Window 2206 reveals that the alarm was reported by CSR-A-1021 and window 2210 provides the location of the vessel, and the time the alarm occurred. Once the CSR is identified, system personnel may use the CSR number to obtain vessel identification.

Referring to FIG. 22B, a detail sensor status display screen 2220 is provided. Display 2220 may provide a photograph 2222 (or another visual depiction) of the vessel. Window 2224 provides a vessel location history. Finally, window 2226 provides sensor details that include vessel ID, sensor polling and battery check, and battery conditions. Those of ordinary skill in the art will recognize that other sensor data may also be displayed. For example, display 2220 may also provide temperature, VSWR, circuit interrupt, and/or NBC alarm data on demand from users.

Referring to FIG. 22C, port of call history screen 2240 may also be obtained by a user on demand. Window 2242 shows the route taken by the vessel. Navigational data points 2246 are plotted on map 2242. The data points 2246 correspond to GPS navigational fixes that were taken by the CSR on-board the vessel. As described above, this data is routinely transmitted to CAMS 40, and stored in the CAMS database 416. Data point 2248 shows the position of the vessel when the alarm was generated. Window 2244 displays the port of call history, showing the port of origin, sequence ports, and the destination port.

Those of ordinary skill in the art will also recognize that the user-interface of the present invention may include a suite of navigation commands that allow the user to navigate the various display screens. In another embodiment, the user-interface includes a microphone and allows the user to select any icon by speaking the name of the icon.

It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents.

What is claimed is:

1. A transportation security system for monitoring at least one freight shipping container being transported by at least one cargo transport vehicle, the system comprising:
a container locking seal configured to be removably coupled to the at least one freight shipping container to thereby seal the at least one freight shipping container when in a coupled position, the container locking seal including at least one anti-tamper sensor and a seal communications device; and
a state recorder disposed in the at least one cargo transport vehicle, the state recorder including a recorder communications system being configured to communicate with the seal communications device, the state recorder also including a data storage module configured to store sensor data.

2. The system of claim 1, wherein the seal communications device includes a passive RF transmitter.

3. The system of claim 2, wherein the passive RF transmitter is configured to transmit an RF transmission in response to being interrogated by the state recorder.

4. The system of claim 1, wherein the seal communications device and the recorder communications system each include a wireless RF transceiver.

5. The system of claim 1, wherein the seal communications device and the recorder communications system each include an RF ultra-wideband transceiver.

6. The system of claim 5, wherein the container locking seal further comprises at least one sensor.

7. The system of claim 6, wherein the container locking seal is remotely driven from a quiescent state to an active state by the state recorder.

8. The system of claim 7, wherein the RF ultra-wideband transceiver and the at least one sensor in the container seal are enabled in the active state.

9. The system of claim 1, wherein the at least one freight shipping container includes a plurality of shipping containers, each of the plurality of shipping containers being sealed by one container locking seal.

10. The system of claim 9, wherein each container locking seal disposed on the plurality of shipping containers is interrogated by the state recorder in a random poling mode.

11. The system of claim 9, wherein each of the plurality of container locking seals is interrogated by the state recorder in a broadcast mode.

12. The system of claim 1, wherein the container seal further comprises an acoustic ultrasonic transducer, the acoustic transducer being activated in response to an alarm generated by the at least one anti-tamper sensor.

13. The system of claim 1, wherein the seal communications device is configured to generate an alarm transmission to the state recorder in response to an alarm generated by the at least one anti-tamper sensor.

14. The system of claim 1, wherein the container seal further comprise a battery.

15. The system of claim 14, wherein the container communications device is configured to generate an alarm transmission to the state recorder in response to a low battery level.

16. The system of claim 1, wherein the state recorder further comprises:
a base module coupled to the cargo transport vehicle, the base module including a power supply; and
a hand-held module removably coupled to the base module, the hand-held module including a user interface.

17. The system of claim 1, further comprising a container alarm monitoring system (CAMS), the CAMS including a CAMS communications facility configured to communicate with the state recorder and at least one existing telecommunications network, the CAMS being configured to receive data from each of the plurality of state recorders and notify at least one enforcement entity in the event of an alarm condition.

18. The system of claim 17, wherein the recorder communications system includes a satellite communications transceiver, the satellite communications transceiver being configured to communicate with the CAMS communications facility via a satellite communications channel.

19. The system of claim 17, wherein the at least one anti-tamper sensor includes an internal circuit interrupt sensor, the internal circuit interrupt sensor being configured to generate a circuit interrupt signal in response to the body of the container seal being cut.

20. The system of claim 19, wherein the seal communications device is configured to transmit a circuit interrupt alarm to the state recorder in response to the circuit interrupt signal.

21. The system of claim 20, wherein the circuit interrupt alarm is transmitted from the state recorder to the CAMS.

22. The system of claim 19, wherein the at least one anti-tamper sensor includes a temperature sensor, the temperature sensor being configured to generate a thermal alarm signal in response to a thermal excursion outside a predetermined temperature range.

23. The system of claim 22, wherein the seal communications device is configured to transmit a temperature alarm to the state recorder in response to the thermal alarm signal.

24. The system of claim 23, wherein the state recorder is configured to transmit the temperature alarm to the CAMS.

25. The system of claim 17, wherein the at least one anti-tamper sensor includes a voltage standing wave ratio (VSWR) detector configured to generate an RF tampering signal in the presence of a VSWR exceeding a predetermined level.

26. The system of claim 25, wherein the seal communications device is configured to transmit an RF tampering alarm to the state recorder in response to the RF tampering signal.

27. The system of claim 26, wherein the state recorder is configured to transmit the RF tampering alarm to the CAMS.

28. The system of claim 17, wherein the container seal further comprises a battery.

29. The system of claim 28, wherein the container seal further comprises a low battery level sensor that is configured to generate a low battery level signal in response to a low battery level condition.

30. The system of claim 29, wherein the container communications device is configured to transmit a low battery alarm to the state recorder in response to the low battery level signal.

31. The system of claim 30, wherein the state recorder is configured to transmit the low battery alarm to the CAMS.

32. The system of claim 28, wherein the battery is a lithium ion battery.

33. The system of claim 17, wherein the state recorder further comprises a global positioning system (GPS) device, the GPS device generating state recorder location data.

34. The system of claim 32, wherein the state recorder is configured to transmit state recorder location data to the CAMS.

35. The system of claim 17, wherein the state recorder further comprises:
a base module coupled to the cargo transport vehicle, the base module including a power supply; and
a hand-held module removably coupled to the base module, the hand-held module including a user interface.

36. The system of claim 17, wherein the power supply includes is configured to receive electrical power from the cargo transport vehicle.

37. The system of claim 36, wherein the power supply includes a battery, the power supply being configured to obtain electrical power when the electrical power from the cargo transport vehicle is interrupted.

38. The system of claim 37, wherein the state recorder is configured to transmit a power interrupt alarm to the CAMS when the electrical power from the cargo transport vehicle is interrupted.

39. The system of claim 17, wherein the state recorder further includes a container position information recovery beacon (CPIRB), the CPIRB being configured to obtain GPS location data.

40. The system of claim 39, wherein the CPIRB is configured to transmit CSR data to the CAMS via a satellite communications channel.

41. The system of claim 17, wherein the at least one cargo transport vehicle includes a plurality of cargo transport vehicles.

42. The system of claim 45, wherein the CAMS is configured to track each cargo transport vehicle.

43. The system of claim 42, wherein the CAMS further comprises:
a satellite communications facility configured to communicate with the state recorder disposed on each of the plurality of cargo transport vehicles; and
at least one computer network coupled to the satellite communications facility, the at least one computer network being configured to,
evaluate data received from each of the state recorders,
detect alarm conditions based on the data, and
notify at least one governmental entity by transmitting an alarm message via the at least one existing telecommunications network

44. The system of claim 43, wherein the at least one computer network is configured to generate control messages to each of the plurality of state recorders, the control messages being transmitted to the state recorders via the satellite communications facility.

45. The system of claim 44, wherein the control messages are configured to remotely activate at least one selected state recorder.

46. The system of claim 43, wherein the at least one computer network includes a LAN or a WAN.

47. The system of claim 43, wherein the at least one computer network includes at least one server computer.

48. The system of claim 43, wherein the at least one computer network includes a database.

49. The system of claim 43, wherein the at least one computer network includes a command and control display system.

50. The system of claim 17, wherein the at least one shipping container includes at least one container contaminant sensor configured to generate a contaminant alarm signal in response to detecting nuclear, biological, and/or chemical material.

51. The system of claim 50, wherein the state recorder is configured to transmit the contaminant alarm to the CAMS.

52. The system of claim 1, wherein the cargo transport vehicle is a vessel or a barge.

53. The system of claim 1, wherein the cargo transport vehicle is an aircraft.

54. The system of claim 1, wherein the cargo transport vehicle is a truck and/or trailer.

55. The system of claim 1, wherein the cargo transport vehicle is a bus.

56. The system of claim 1, wherein the cargo transport vehicle is a train.

57. A security system for monitoring a plurality of shipping containers being transported by a plurality of cargo transport vehicles, each of the plurality of cargo vehicles transporting at least one shipping container, the system comprising:
a plurality of container locking seals, each locking seal of the plurality of locking seals being configured to be removably coupled to one freight shipping container to thereby seal the freight shipping container when in a coupled position, each container locking seal including at least one anti-tamper sensor and a seal transceiver;
a plurality of state recorders, each state recorder of the plurality of state recorders being disposed in one cargo transport vehicle, each state recorder including a recorder communications system configured to communicate with each seal transceiver disposed in the one cargo transport vehicle, the state recorder also including a data storage module configured to store data received from each locking seal disposed in the one cargo transport vehicle; and
a container alarm monitoring system (CAMS) in communication with each of the plurality of state recorders in the system, the CAMS being configured to receive data from each of the plurality of state recorders and notify at least one enforcement entity in the event of an alarm condition.

58. A method for monitoring at least one freight shipping container being transported by at least one cargo transport vehicle, the method comprising:
providing a container locking seal configured to be removably coupled to the at least one freight shipping container to thereby seal the at least one freight shipping container when in a coupled position, the container locking seal including at least one anti-tamper sensor and a seal communications device; and
communicating with the seal communications device to obtain sensor data from the at least one anti-tamper sensor.

59. The method of claim 58, wherein the step of communicating further comprises the step of remotely controlling the container locking seal by transmitting at least one command to the seal communications device.

60. The method of claim 59, wherein the step of remotely controlling the container locking seal includes the step of driving the container locking seal from a quiescent state to an active sensor state.

61. The method of claim 58, further comprising the step of storing sensor data.

62. The method of claim 58, further comprising the steps of:
analyzing the sensor data;
detecting an alarm condition based on the step of analyzing; and
transmitting the alarm condition to at least one governmental entity.

63. The method of claim 62, wherein the step of transmitting is performed using a pre-existing telecommunications system.

64. The method of claim 62, wherein the alarm condition includes a circuit interrupt alarm that is generated in response to the body of the container seal being cut.

65. The method of claim 62, wherein the alarm condition includes a thermal alarm signal in response to the at least one anti-tamper sensor detecting a thermal excursion outside a predetermined temperature range.

66. The method of claim 62, wherein the alarm condition includes RF tampering alarm in response to the at least one anti-tamper sensor detecting a VSWR exceeding a predetermined level.

67. The method of claim 62, wherein the alarm condition includes a low battery level alarm in response to a low battery level condition in the container locking seal.

68. The method of claim 62, wherein the alarm condition is generated in response to a detection of nuclear material in the at least one freight shipping container.

69. The method of claim 62, wherein the alarm condition is generated in response to a detection of biological material in the at least one freight shipping container.

70. The method of claim 62, wherein the alarm condition is generated in response to a detection of a chemical agent in the at least one freight shipping container.

71. The method of claim 62, wherein the container locking seal is configured to transmit an acoustic ultrasonic alarm signal in response to detecting the alarm condition.

72. The method of claim 58, wherein the step of communicating includes the step of transmitting alarm data to a remote facility by way of a satellite communications channel.

73. A method for monitoring at least one freight shipping container being transported by at least one cargo transport vehicle from an point of origin to a destination point, the method comprising:
providing route data corresponding to the path traversed by the at least one cargo transport vehicle from an point of origin to a destination point;
monitoring an actual position of the at least one cargo vehicle to determine whether the actual position of the vehicle corresponds to the route data;
generating an alarm condition if the actual position of the vehicle does not correspond to the route data; and
notifying at least one governmental entity of the alarm condition.

74. A computer readable medium having stored thereon a data structure for packetizing data being transmitted between a container locking seal and a state recorder, the container locking seal being configured to be removably coupled to the at least one freight shipping container disposed on a cargo transport vehicle, the state recorder being disposed on the cargo transport vehicle, the data structure comprising:
a container locking seal identification field containing data that uniquely identifies the container locking seal; and
a payload field containing either locking seal status data or state recorder command data depending on the source of the packet.

75. The data structure of claim 74, wherein the payload field in packets transmitted from the locking seal to the state recorder include status data, the status data representing an output signal of at least one sensor disposed in the container locking seal.

76. The data structure of claim 75, wherein the status data includes an alarm status of a temperature sensor disposed in the locking seal.

77. The data structure of claim 75, wherein the status data includes an alarm status of a VSWR sensor disposed in the locking seal.

78. The data structure of claim 75, wherein the status data includes an alarm status of a circuit interrupt sensor disposed in the locking seal.

79. The data structure of claim 75, wherein the status data includes an alarm status of at least one of a nuclear, biological, or chemical sensor disposed in a container.

80. The data structure of claim 74, wherein the payload field in packets transmitted from the state recorder to the locking seal includes command data, the command data being utilized by the locking seal to perform a corresponding task.

81. A computer readable medium having stored thereon a data structure for packetizing data being transmitted between a state recorder and a remote container alarm monitoring system (CAMS), the state recorder being configured to monitor At least one container locking seal configured to be removably coupled to the at least one freight shipping container disposed on a cargo transport vehicle, the state recorder being disposed on the cargo transport vehicle, the data structure comprising:
a state recorder identification field containing data that uniquely identifies the container locking seal; and
a payload field containing either state recorder status data or CAMS command data depending on the source of the packet.

82. The data structure of claim 81, wherein the state recorder status data includes a location field, corresponding to the location of the state recorder, a time and date field corresponding to the time and date the packet was generated, a state recorder status field, and a container locking seal status field.

83. The data structure of claim 81, wherein the payload field in packets transmitted from the CAMS to the state recorder includes CAMS command data, the command data being utilized by the state recorder to perform a task.

84. In a computerized system for identifying, detecting, and notifying personnel of alarm conditions based on data being transmitted from a state recorder to a container alarm monitoring system (CAMS), the state recorder being configured to monitor at least one container locking seal configured to be removably coupled to the at least one freight shipping container disposed on a cargo transport vehicle, the state recorder being disposed on the cargo transport vehicle, the CAMS having a graphical user interface including at least one display and at least one selection device, a method for providing and selecting from a menu on the display, the method comprising:
retrieving a threat identification display screen;
displaying a plurality of threat mode icons on the threat identification display screen;
processing a selection signal generated by the at least one selection device by pointing the at least one selection device at one of the plurality of threat mode icons; and
displaying a threat mode display screen corresponding to the selected threat mode icon in response to the step of processing.

85. The method of claim 84, wherein the threat mode display screen includes an intermodal threat identification detection and notification (ITIDN) display, the ITIDN display providing a composite view of all threat modes being monitored by CAMS.

86. The method of claim 85, wherein the ITIDN display screen displays a threat status for every cargo vehicle being tracked by the system, the threat status including a confirmed red alarm status, a potential yellow alarm status, and a normal green alarm status.

87. The method of claim 86, wherein the threat mode display screen includes an aircraft threat identification detection and notification (ITIDN) display, the ITIDN being configured to display a threat status of each aircraft being tracked by the system, the threat status including a confirmed red alarm status, a potential yellow alarm status, and a normal green alarm status.

88. The method of claim 86, wherein the threat mode display screen includes an rail threat identification detection and notification (ATIDN) display, the ATIDN being configured to display a threat status of each train being tracked by the system, the threat status including a confirmed red alarm status, a potential yellow alarm status, and a normal green alarm status.

89. The method of claim 86, wherein the threat mode display screen includes an aircraft threat identification detection and notification (TTIDN) display, the TTIDN being configured to display a threat status of each truck/trailer being tracked by the system, the threat status including a confirmed red alarm status, a potential yellow alarm status, and a normal green alarm status.

90. The method of claim 86, wherein the threat mode display screen includes an aircraft threat identification detection and notification (VTIDN) display, the VTIDN being configured to display a threat status of each vessel/barge being tracked by the system, the threat status including a confirmed red alarm status, a potential yellow alarm status, and a normal green alarm status.

91. The method of claim 86, further comprising the step of displaying an alert inventory display screen, the alert inventory display screen including an alert inventory window and a current alert status window.

92. The method of claim 91, wherein the alert inventory window further comprises:
a first pull-down menu allowing a user to view a status of each threat type by using the at least one selection device, the threat type including rail, vessel, truck, or air; and
a second pull down menu allowing the user to sort each threat type by date, time, or other criteria, via the at least one selection device.

93. The method of claim 92, wherein the current alert status window displays the current status of both red and yellow level alerts for a selected threat type.

94. The method of claim 84, wherein the threat mode display screen includes a map of an area being monitored.

95. The method of claim 94, wherein a user obtains detail view of a portion of the map by using the at least one selection device.

96. The method of claim 94, wherein a user obtains an enlarged view of the map by using the at least one selection device.

97. The method claim 84, further comprising the step of displaying a route deviation alert, in response to the computerized system detecting a cargo vehicle deviating from a pre-registered route plan stored in a memory accessible by the computerized system.

98. The method of claim 97, further comprising a cargo details display screen, the cargo details display screen including cargo identification information, a description of the cargo vehicle, a cargo vehicle pilot identifier, cargo vehicle speed, and nearest point of intercept.

99. The method claim 84, further comprising the step of displaying a notification/response detail screen, the notification/response detail screen comprising:
a law enforcement notification window configured to identify each agency contacted, a time when the agency was contacted, and a time the agency responded;
a notification summary window including cargo vehicle details such as cargo identification information, a description of the cargo vehicle, a cargo vehicle pilot identifier, cargo vehicle speed, and nearest point of intercept; and
a map detail window showing the location of the cargo vehicle.
